(19) United States
(12) Patent Application Publication
(10) Pub. No.: US 2008/0232368 A1
(43) Pub. Date: Sep. 25, 2008

(54) NETWORK SYSTEM

(76) Inventors: Kozo Ikegami, Yokohama (JP); Hiroaki Miyata, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/022,376

(22) Filed: Jan. 30, 2008

(30) Foreign Application Priority Data
Mar. 19, 2007 (JP) 2007-071241

(51) Int. Cl. H04L 12/56

(52) U.S. Cl. 370/390

(57) ABSTRACT

When a user terminal makes a connection request, a router acquires a group address that the user terminal can join from an authentication server. The router gives information of the router to a packet during joining check (Query) and transmits the packet to a layer 2 switch. The layer 2 switch can grasp, by receiving the joining checks which group address the user terminal can join. The layer 2 switch can perform delivery control involving authentication. The layer 2 switch collects information necessary for accounting such as delivery start and end times and traffic and transmits the information to the router. The router creates accounting information on the basis of the information and transmits the accounting information to the accounting server.

### BACKGROUND OF THE INVENTION

1. Field of the Invention

The present invention relates to a network system, and, more particularly to a network system for performing authentication and accounting in multicast used for content information delivery such as broadcasts.

2. Description of the Related Art

When unicast communication is used for broadcast-type communication, a server that delivers data and a user terminal that receives the data are in a one to one relation. The delivery server simultaneously delivers data equivalent to the number of user terminals. Therefore, a heavy load is applied to the delivery server and traffic increases.

To solve such problems, there is multicast communication as a broadcast-type communication technique for simultaneously delivering data to specific plural destinations. In the technique, Internet Group Membership Protocol (IGMP: see RFC1112 and RFC2236) and Multicast Listener Discovery (MLD: see RFC2710), which are standards in Internet Engineering TaskForce (IETF), are installed in packet transfer apparatuses (routers, gateways, etc.) set between the deliver server and the user terminals. The packet transfer apparatuses copy the data from the delivery server and transmit the data only to user terminals that request delivery. Consequently, since the delivery server only has to copy the data from the delivery server and transmit the data to the packet transfer apparatuses, a load on the delivery server is controlled and traffic between the delivery server and the packet transfer devises is also controlled.

When a data delivery service is performed using multicast communication, authentication and accounting may be necessary. As an example of a method of realizing authentication and accounting, Internet Group membership Authentication Protocol (IGAP:http://www.potaroo.net/ietf/all-ids/draft-hayashi-igap-03.txt) is a draft of IETF. In the method, user identification information and information necessary for authentication such as a password are added to an IGMP packet and a multicast router makes an inquiry to an authentication and accounting server on the basis of the information using Remote Authentication Dial In User Service (RADIUS: see RFC2865 and RFC2866). The multicast router judges, on the basis of a result of the inquiry, whether data should be delivered to user terminals that request delivery. Accounting processing is also possible on the basis of a connection record.

When the method is used, as the number of user terminals increases, a lager number of expensive multicast routers are necessary. A technique for reducing expensive multicast routers as much as possible is disclosed in, for example, JP-A-2004-357200. In this technique, a function of snooping an IGAP packet is given to a layer 2 switch and the like set between user terminals and routers to control data delivery with the layer 2 switch. This makes it possible to control the number of routers. The technique disclosed in Japanese Patent Application Laid-Open No. 2004-357200 is implemented on condition that user terminals subordinate to the layer 2 switch are present in an identical sub-network. When the user terminals are present in the identical sub-network, security is loose.

On the other hand, in an actual access network in which the service employing multicast communication is performed, user terminals and a router are often connected by PPPoE (point to point Protocol over Ethernet: see RFC2516). When PPPoE is used, the user terminals and the router are logically connected point to point. Therefore, when multicast communication is performed on such a network, the router can be logically connected to user terminals larger in number than the number of lines of the router. This makes it possible to control the number of multicast routers by once terminating the user terminals with the layer 2 switch, perform authentication and accounting in multicast, and control of delivery data. Moreover, in this case, during PPPoE authentication for the user terminals, the router receives information indicating which multicast groups users can join from an authentication server and acquires a correspondence table for PPPoE and multicast. Therefore, when the router receives delivery requests from the user terminals, the router can judge propriety of delivery without making an inquiry to the authentication server (see, for example, JP-A-2006-42223 and JP-A-2006-148750).

However, when the user terminals and the router are connected point to point as described above, the router has to copy delivery data by a number of user terminals connected subordinately to the router and transmit the delivery data to the user terminals. Therefore, traffic between the layer 2 switch and the router increases by the number of user terminals compared with the case of JP-A-2004-357200. Moreover, a load is applied to the router that copies the delivery data.

One of techniques for solving the problem is disclosed in JP-A-2006-109047. In this technique, when user terminals and a router are logically connected point to point, a layer 2 switch set between the user terminals and the router forms a connection exclusively used for multicast between the layer 2 switch and the router, receives, copies, and transmits delivery data on behalf of the user terminals connected subordinately to the layer 2 switch. Consequently, it is possible to control traffic between the layer 2 switch and the router and reduce a load on the router.

### SUMMARY OF THE INVENTION

When a data delivery service is carried out using multicast communication in the network in which the user terminals and the router are logically connected point to point by PPPoE or the like for security and user management, in the technique disclosed in JP-A-2006-109047, the layer 2 switch set between the user terminals and the router performs a delivery request and reception of delivery data on behalf of the user terminals connected subordinately to the layer 2 switch. Consequently, it is possible to reduce traffic and a load on the router.

However, the router receives delivery requests from the layer 2 switch rather than from the user terminals and transmits delivery data to the layer 2 switch rather than delivering data to the user terminals. Therefore, since the router cannot grasp user information concerning multicast packets, the router may not be able to perform authentication and accounting during a multicast service according to IGAP and the method disclosed in JP-A-2006-148750.

For example, when a user terminal connected subordinately to the layer 2 switch requests delivery of certain multicast data to the user terminal, the delivery request is received by the layer 2 switch and the layer 2 switch requests delivery of the multicast data to the layer 2 switch on behalf of the user terminal. Therefore, since the router receives the request for delivery to the layer 2 switch, the router has no means for learning which user terminal makes the delivery request. As a result, the router may not be able to make an inquiry to the authentication server for authentication and the like of the user terminal.

Since the router delivers the multicast data to the layer 2 switch in response to the delivery request from the layer 2 switch, the router cannot see which terminal is receiving the data. Therefore, the router may not be able to perform accounting for each of the user terminals using an accounting server or the like.

Moreover, the router may not be able to judge propriety of delivery, i.e., to judge to which terminals delivery of the multicast data is permitted and to which terminals delivery of the multicast data is rejected.

The present invention has been devised in view of the circumstances and it is an object of the present invention to provide a network system having means for allowing a router to learn user information managed by a layer 2 switch on a network and means with which the router performs processing for authentication and accounting on the basis of the user information. It is another object of the present invention to provide means with which the layer 2 switch controls delivery data on the basis of an authentication result. It is still another object of the present invention to provide a network system for realizing an inexpensive multicast service involving authentication and accounting while controlling traffic.

It is still another object of the present invention to realize various authentication and accounting services and user management with an inexpensive apparatus configuration and while controlling traffic and a load on the apparatus when, for security and user management, a data delivery service by multicast communication is performed on an access network in which user terminals and a router are logically connected point to point in PPPoE and the like.

It is still another object of the present invention to realize authentication and accounting services and user management without imposing a burden on a user because new addition of functions and setting in a user terminal are unnecessary and, since only authentication of PPP connection has to be performed, a user ID (a user identifier) and a password for multicast are unnecessary, and the user does not need to be authenticated again to receive a multicast service.

When a user terminal requests a router to perform PPP connection, the router receives the request and makes an inquiry to an authentication server. The authentication server manages information concerning a user ID, a password, and a group address that the user can join. The authentication server transmits a result of authentication for PPP connection and the group address that the user can join to the router. Thereafter, when a joining request (Join) for joining a certain multicast group is transmitted from the user terminal, a layer 2 switch terminates the joining request (Join) from the user terminal. However, since the layer 2 switch cannot see whether delivery to the user terminal is permitted or rejected, the layer 2 switch transmits the joining request (Join) given with information concerning the user terminal to the router.

The router compares information concerning the joining request and user information received from the authentication server. When there is a difference between these kinds of information, the router gives information held by the router to a joining check (Query) and transmits the joining check to the layer 2 switch. According to the information from the router, the layer 2 switch can see whether delivery to the user terminal is permitted or rejected and can judge whether data should be delivered to the user terminal. Moreover, the layer 2 switch always maintains consistency between information of the router and information of the layer 2 switch according to a periodical joining check (Query) of the router. Consequently, the layer 2 switch alone can judge whether delivery is permitted or rejected without seeking confirmation of the router as described above. However, when the user terminal is permitted to join a certain group address after PPP connection, it is necessary to update the information of the router. Therefore, when none of pieces of user information from the layer 2 switch corresponds to user information managed by the router, the router makes an inquiry to the authentication server again. The router updates the user information of the router and transmits the updated information to the layer 2 switch. Consequently, the layer 2 switch can grasp latest user information.

When the layer 2 switch sets a certain user terminal as “rejected”, even if the user terminal is permitted to join a group address, as long as the user terminal makes PPP reconnection, the layer 2 switch sets the user terminal as “permitted” unless the router has an opportunity of making an inquiry to the authentication server. Therefore, a term of validity is provided for user information set as “rejected” by the layer 2 switch. After the term of validity is expired, when a joining request (Join) is received from the user terminal, the router makes an inquiry to the authentication server. This makes it possible to update the user information of the layer 2 switch even if the user terminal does not make PPP reconnection.

The layer 2 switch records not only permission and rejection of delivery but also a log of actual delivery to the user terminal. When the user terminal leaves a group address in which the user terminal has been joining, with this as an opportunity, the layer 2 switch transmits the deliver log to the router. The router adds information necessary for accounting such as a user ID to the delivery log and transmits the delivery log to the accounting server to make it possible to perform accounting. Examples of the opportunity for leaving the group address include an opportunity at the time when the layer 2 switch receives a declaration of leaving from the user terminal, an opportunity at the time when there is no response (Report) to joining check (Query) from the layer 2 switch to the user terminal, and an opportunity at the time when PPP connection is disconnected. At the first and second opportunities, the layer 2 switch can recognize the leaving. However, at the third opportunity, the layer 2 switch alone cannot recognize the leaving. Therefore, the router that can learn that PPP connection is disconnected gives the user information to the joining check (Query) and transmits the joining check to the layer 2 switch when PPP connection is disconnected. Consequently, the layer 2 switch can recognize the disconnection.

Moreover, at the time of PPP connection, the authentication server transmits not only a group address that the user can join but also a term of validity of the joining. When the router transmits user information to the layer 2 switch, the router adjusts a term of validity of the user information to the term of validity of the joining. The layer 2 switch sets delivery as “permitted” during the term of validity to make it possible to perform, for example, prepaid accounting. In this case, it is possible that traffic is designated instead of the term of validity and, when data is delivered up to certain traffic, the delivery is stopped.

As another means for an accounting methods a multicast control packet is not terminated by the layer 2 switch but is snooped by the layer 2 switch to update a delivery control table and is transferred in the same manner as a normal packet. The router notifies the charging server of the start of accounting with the reception of a joining request (join) from the user terminal as an opportunity. For example, when a leaving declaration (Leave) from the user terminal is received, when there is no response (Report) to the joining check (Query), when PP connection is disconnected, the router notifies the charging server of the end of accounting. The charging server can perform accounting by grasping time when the user terminal joins the group address and time when the user terminal leaves the group address. When the end of accounting is notified, the router transmits accounting information from the layer 2 switch to the accounting server together with the notification, whereby more accurate accounting and metered accounting.

In the present invention, as means for solving the problem, the layer 2 switch and the router include, for example, plural line interfaces, a line-interface control unit, a processor that performs packet analysis/editing processing. As a table held on a memory, the layer 2 switch and the router include a table for managing user information and a table for managing multicast connection between the apparatuses.

A second packet transfer apparatus (a router) according to the present invention is, for example, a packet transfer apparatus connected to plural user terminal point to point. The second packet transfer apparatus includes a user management table for managing the user terminals, a multicast connection management table for managing multicast connection to a subordinate packet transfer apparatus connected subordinately to the second packet transfer apparatus, and a processor that performs processing for receiving a multicast packet from the subordinate packet transfer apparatus connected subordinately to the second packet transfer apparatus. When the processor receives user information from the subordinate packet transfer apparatus connected subordinately to the second packet transfer apparatus, the processor compares the user information with the user management table managed by the second packet transfer apparatus. When delivery permission is unclear in user information of the subordinate packet transfer apparatus, the processor transmits user information of the second packet transfer apparatus to the subordinate packet transfer apparatus. When the user information of the subordinate packet transfer apparatus is not present in the user information of the second packet transfer apparatus, the processor makes an inquiry to an authentication server.

A first packet transfer apparatus (a layer 2 switch) according to the present invention is, for example, a subordinate packet transfer apparatus that is connected subordinately to the second packet transfer apparatus and terminates plural user terminals. The first packet transfer apparatus includes a delivery control table for controlling delivery to the user terminals, a multicast connection management table for managing multicast connection to the second packet transfer apparatus connected above the first packet transfer apparatus, and a processor that performs processing for receiving a multicast packet from the user terminals connected subordinately to the first packet transfer apparatus. When the processor receives the multicast packet from the user terminal connected subordinately to the first packet transfer apparatus, the processor updates a delivery control table and transmits user information to the superior packet transfer apparatus at the time of response to a joining request or a joining check. When the processor receives user information from the superior packet transfer apparatus, the processor updates the delivery control table on the basis of the information and performs control for transferring the multicast packet to the respective user terminals on the basis of information of the delivery control table.

In the first packet transfer apparatus, information necessary for accounting is recorded in the user management table. When the processor receives a leaving declaration from the user terminal, when there is no response to a joining check from the user terminal, or when the processor stops delivery when the user information is received from the superior packet transfer apparatus and the delivery control table is updated, the processor transmits the user information to the superior packet transfer apparatus.

When PPP connection of the user terminal is disconnected, the second packet transfer apparatus updates the delivery information table and transmits the delivery information table to the subordinate packet transfer apparatus.

When the second packet transfer apparatus receives user information including accounting information from the subordinate packet transfer apparatus, the second packet transfer apparatus adds the user information managed by the second packet transfer apparatus and transmits the user information to the accounting server.

According to the first solving means of this invention, there is provided a network system comprising:

a first packet transfer apparatus that terminates plural user terminals, copies received multicast data, and transfers the multicast data to each of the user terminals;

a second packet transfer apparatus that communicates with the plural user terminals point to point through the first packet transfer apparatus; and

a server that outputs a group address of a multicast group that the user terminal can join to the second packet transfer apparatus,

wherein

the first packet transfer apparatus includes a delivery control table in which entries including a group address, terminal identification information of the user terminal and information indicating delivery permission or delivery rejection are stored,

the second packet transfer apparatus receives a connection request for point to point connection from the user terminal and acquires the group address of the multicast group that the user terminal can join from the server,

the second packet transfer apparatus stores the acquired group address and the terminal identification information of the user terminal in association with each other,

the first packet transfer apparatus receives, from the user terminal, a first joining request that is for joining a multicast group and includes the group address set in advance and the terminal identification information of the user terminal and is set the user terminal as a transmission source, terminates the first joining request, and stores the group address and the terminal identification information in the delivery control table in association with each other,

the first packet transfer apparatus transmits a second joining request that includes the received group address and terminal identification information and is set the first packet transfer apparatus itself as a transmission source to the second packet transfer apparatus,

the second packet transfer apparatus compares the group address and the terminal identification information included in the second joining request and the stored group address and the stored terminal identification information, and transmits, to the first packet transfer apparatus, notification indicating delivery permission when the group address and terminal identification information coinciding with the group address and the terminal identification information included in the second joining request are stored, and notification indicating delivery rejection when the group address and terminal identification information coinciding with the group address and the terminal identification information included in the second joining request are not stored,

the first packet transfer apparatus stores information indicating delivery permission or delivery rejection in the delivery control table in association with the group address and the terminal identification information in accordance with the notification, and

the first packet transfer apparatus receives multicast data including the group address from the second packet transfer apparatus and transmits, with reference to the delivery control table, the received multicast data and/or the copied multicast data to one user terminal or the plural user terminals in accordance with the terminal identification information of the entries in which the information indicating delivery permission is stored in association with the group address.

According to the second solving means of this invention, there is provided a network system comprising:

a first packet transfer apparatus that terminates plural user terminals, copies received multicast data, and transfers the multicast data to each of the user terminals;

a second packet transfer apparatus that communicates with the plural user terminals point to point through the first packet transfer apparatus; and

a server that outputs a group address of a multicast group that the user terminal can join to the second packet transfer apparatus,

wherein

the first packet transfer apparatus includes a delivery control table in which entries including a group address, terminal identification information of the user terminal, information indicating delivery permission or delivery rejection, and information indicating reception or non-reception of a joining request are stored,

the second packet transfer apparatus receives a connection request for point to point connection from the user terminal and acquires the group address of the multicast group that the user terminal can join from the server,

the second packet transfer apparatus transmits notification including the acquired group address and the terminal identification of the user terminal to the first packet transfer apparatus,

the first packet transfer apparatus stores the group address and the terminal identifier included in the notification and the information indicating delivery permission into the delivery control table in association with each other,

the first packet transfer apparatus receives, from the user terminal, a joining request for joining a multicast group including the group address set in advance and the terminal identification information of the user terminal and stores information indicating reception of the joining request in association with corresponding group address and terminal identification information of the delivery control table, and

the first packet transfer apparatus receives multicast data including the group address from the second packet transfer apparatus, and transmits, with reference to the delivery control table, the received multicast data and/or the copied multicast data to one user terminal or the plural user terminals in accordance with the terminal identification information of the entries in which the information indicating reception of the joining request and the information indicating delivery permission are stored in association with the group address.

According to the third solving means of this invention, there is provided a network system comprising:

a first packet transfer apparatus that terminates plural user terminals, copies received multicast data, and transfers the multicast data to each of the user terminals;

a second packet transfer apparatus that communicates with the plural user terminals point to point through the first packet transfer apparatus; and

a server that outputs a group address of a multicast group that the user terminal can join to the second packet transfer apparatus and receives accounting start notification and accounting end notification to thereby perform accounting for each of pieces of terminal identification information,

wherein

the first packet transfer apparatus includes a delivery control table in which entries including a group address, terminal identification information of the user terminal and information indicating delivery permission or delivery rejection are stored,

the second packet transfer apparatus receives a connection request for point to point connection from the user terminal and acquires the group address of the multicast group that the user terminal can join from the server,

the second packet transfer apparatus stores the acquired group address and the terminal identification information of the user terminal in association with each other,

the first packet transfer apparatus receives, from the user terminal, a joining request for joining a multicast group including the group address set in advance and the terminal identification information of the user terminal, snoops the joining request, stores the group address and the terminal identification information in the delivery control table, and transfers the joining request to the second packet transfer apparatus,

the second packet transfer apparatus transmits the accounting start notification including the group address and/or the terminal identification information included in the received joining request to the server,

the second packet transfer apparatus compares the group address and the terminal identification information included in the received joining request and the stored group address and the terminal identification information, and transmits, to the first packet transfer apparatus, notification indicating delivery permission when the group address and terminal identification information coinciding with the group address and the terminal identification information included in the received joining request are stored, and notification indicating delivery rejection when the group address and terminal identification information coinciding with the group address and the terminal identification information included in the received joining request are not stored,

the first packet transfer apparatus stores information indicating delivery permission or delivery rejection in the delivery control table in association with the group address and the terminal identification information in accordance with the notification,

the first packet transfer apparatus receives multicast data including the group address from the second packet transfer apparatus, and transmits, with reference to the delivery control table, the received multicast data and/or the copied multicast data to one user terminal or the plural user terminals in accordance with the terminal identification information of the entries in which the information indicating delivery permission is stored in association with the group address, and

the second packet transfer apparatus receives a leaving declaration including the group address and the terminal identification information from the user terminal through the first packet transfer apparatus and transmits the accounting end notification including the group address and/or the terminal identification information included in the received leaving declaration to the server.

According to the present invention, it is possible to provide a network system having means for allowing a router to learn user information managed by a layer 2 switch on a network and means with which the router performs processing for authentication and accounting on the basis of the user information. According to the present invention, it is possible to provide means with which the layer 2 switch controls delivery data on the basis of an authentication result. According to the present invention, it is possible to provide a network system for realizing an inexpensive multicast service involving authentication and accounting while controlling traffic.

According to the present invention, it is possible to realize various authentication and accounting services and user management with an inexpensive apparatus configuration and while controlling traffic and a load on the apparatus when, for security and user management, a data delivery service by multicast communication is performed on an access network in which user terminals and a router are logically connected point to point in PPPoE and the like.

According to the present invention, it is possible to realize authentication and accounting services and user management without imposing a burden on a user because new addition of functions and setting in a user terminal are unnecessary and, since only authentication of PPP connection has to be performed, a user ID (a user identifier) and a password for multicast are unnecessary, and the user does not need to be authenticated again to receive a multicast service.

### DESCRIPTION OF THE DRAWINGS

FIG. 1 is a network diagram according to an embodiment of the present invention;

FIG. 2 is a diagram showing a flow of a packet in a technology in the past;

FIG. 3 is a diagram showing a flow of a packet according to the embodiment;

FIG. 4 is a diagram showing an example of an internal structure of a layer 2 switch according to the embodiment;

FIGS. 5A to 5D are diagrams showing an example of a delivery control table of the layer 2 switch;

FIGS. 6A to 6C are diagrams showing an example of a delivery control table of the layer 2 switch;

FIG. 7 is a diagram showing an example of a multicast connection management table of the layer 2 switch;

FIG. 8 is a diagram showing an example of an internal structure of a router according to the embodiment;

FIGS. 9A to 9C are diagrams showing an example of a delivery information table of the router;

FIG. 10 is a diagram showing an example of a multicast connection management table of the router;

FIG. 11A is a diagram of an example of the structure of a packet other than a multicast packet transmitted and received between a user terminal and the router;

FIG. 11B is a diagram of an example of the structure of the multicast packet;

FIG. 12 is a diagram showing an example of a user management table of an authentication and accounting server;

FIG. 13 is a diagram showing an operation sequence from a PPP connection request of a user terminal (H1-1) until the user terminal (H1-1) receives data of multicast;

FIG. 14 is a diagram showing an operation sequence after a state shown in FIG. 13 from a PPP connection request of a user terminal (H1-n) until the user terminal (H1-n) receives data of multicast;

FIG. 15 is a diagram showing an operation sequence after a state shown in FIG. 14 from a PPP connection request of a user terminal (H1-2) until the a multicast joining request is rejected;

FIG. 16 is a diagram showing a processing flow of processing performed when the layer 2 switch receives packets from the user terminals;

FIG. 17 is a diagram showing a processing flow of processing performed when the router receives an IGMP packet from the layer 2 switch;

FIG. 18 is a diagram showing an accounting operation sequence of an accounting operation performed when the user terminals (H1-1 and H1-n) transmit Leave packets and leave a group address;

FIG. 19 is a diagram showing an accounting operation sequence of an accounting operation performed when the user terminal (H1-1) stops returning a Report packet and leaves a group address;

FIG. 20 is a diagram showing an accounting operation sequence of an accounting operation performed when the user terminal (H1-1) leaves a group address because of PPP session disconnection;

FIG. 21 is a diagram showing a processing flow of processing performed when the layer 2 switch receives Leave packets from the user terminals;

FIGS. 22A and 22B are diagrams showing an example of a delivery control table of the layer 2 switch;

FIG. 23 is a diagram showing an example of a delivery information table of the router; and

FIG. 24 is a diagram showing an accounting operation sequence of an accounting operation performed by using means according to a second embodiment of the present invention.

### DETAILED DESCRIPTION OF THE INVENTION

Embodiments of the present invention will be hereinafter explained with reference to the accompanying drawings. In an example explained below, packet transfer is performed by using IPv4 and IGMP. Since a basic operation is the same when IPv6 and MLD are used, explanation of an example of packet transfer performed by using IPv6 and MLD is omitted. In the example explained below, user terminals and a router are connected by PPPoE. However, operations are the same when the user terminals and the router are logically connected point to point in a PPPoA (PPP over ATM), a VLAN (Virtual LAN), and the like. A protocol used in packet transfer is not limited to those described above and an appropriate protocol can be used. A layer 2 switch and the router are explained as examples of apparatuses. However, apparatuses in which the same functions can be installed (e.g., a Broadband Access Server (BAS)) can be appropriately applied as the apparatuses. In the example explained below, an authentication server and an accounting server are explained as an identical server. However, when the authentication server and the accounting server are separately provided, the servers operate in the same manner as at the time when the servers are identical. Moreover, the example is explained on condition that respective kinds of processing are executed by software. However, the processing can be realized by hardware in the same manner.

### 1. First Embodiment

1.1 System configuration

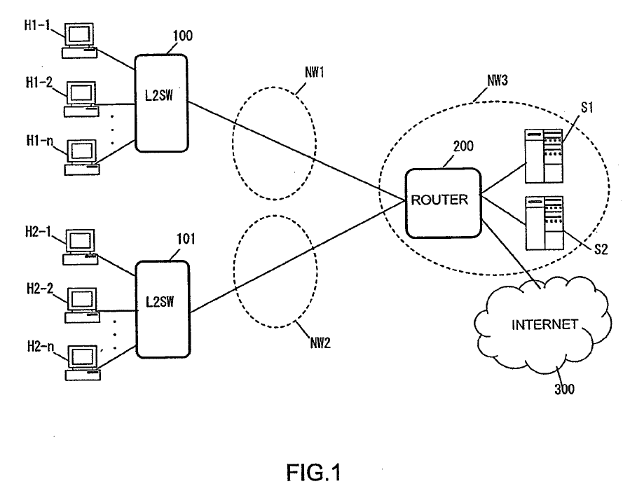

FIG. 1 shows a diagram of a network system according to this embodiment.

The network system includes layer 2 switches (L2SWs, first packet transfer apparatuses) 100 and 101, a router (a second packet transfer apparatus) 200, a content delivery server S1, and an accounting and authentication server S2.

In this example of a network configuration, user terminals (H1-1 to H1-n and H2-1 to H2-n) are once housed in the layer 2 switches (100 and 101). The user terminals are connected to the Internet (300), the content delivery server (S1), and the accounting and authentication server (S2) through access networks (NW1 and NW2) and a router (200) provided in an ISP network (NW3). The user terminals (H1-1 to H1-n and H2-1 to H2-n) and the router (200) are connected by PPPoE.

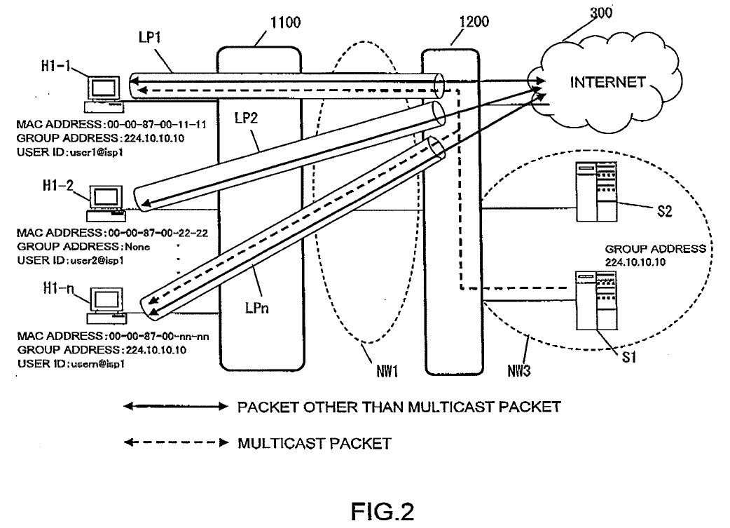

FIG. 2 is a diagram for explaining a flow of a packet performed by using a technique in the past and problems in the technique.

In this explanation, it is assumed that MAC addresses (00-00-87-00-11-11 to 00-00-87-00-nn-nn) and user IDs (user1@isp1, user2@isp1, and usern@isp1) are allocated to the user terminals (H1-1 to H1-n), respectively. The user terminals (H1- to H1-n) and a router (1200) are connected by logical connections (LP1 to LPn). When Internet connection is performed, the user terminals and the router are connected through these connections (LP1 to LPn). The user terminals (H1-1 to H1-n) have agreements with a content provider in advance and have a qualification for joining a multicast group (group address 224.10.10.10). In the case of a multicast packet from the delivery server (S1), the multicast packet is delivered through the connections (LP1 to LPn) in the same manner. A copy point of the multicast packet in this case is the router (1200). Therefore, when the number of user terminals and L2SWs that join the multicast group increases, copies equivalent to the increase in the number are required in the router (1200) and a larger load is applied to the router (1200). Traffic between a layer 2 switch (1100) and the router (1200) also increases.

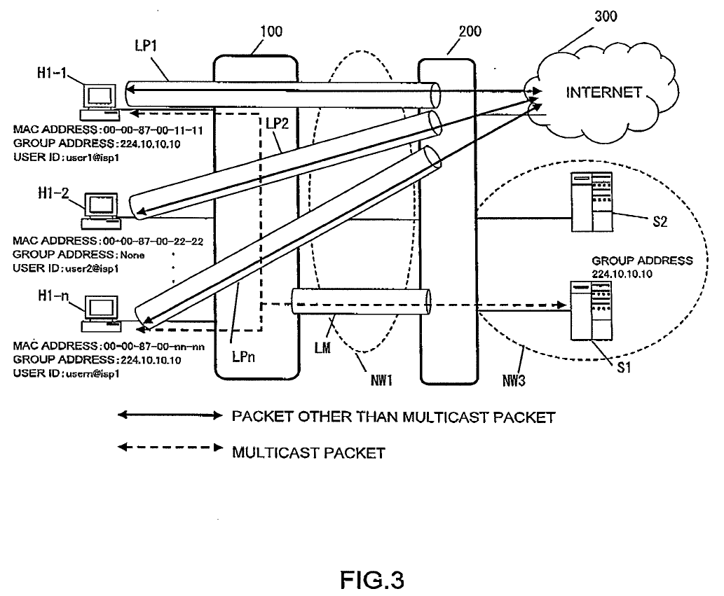

FIG. 3 is a diagram showing a flow of a packet according to this embodiment.

A logical connection (LM) for multicast is formed between the L2SW (100) and the router (200) separately from the logical connections (LP1 to LPn) used for the Internet connection. A multicast packet is delivered through this connection (LM). A copy point of the multicast packet in this case is the layer 2 switch (100). Therefore, even if user terminals that join the group address increase, a load on the router (200) and traffic between the layer 2 switch (100) and the router (200) are controlled.

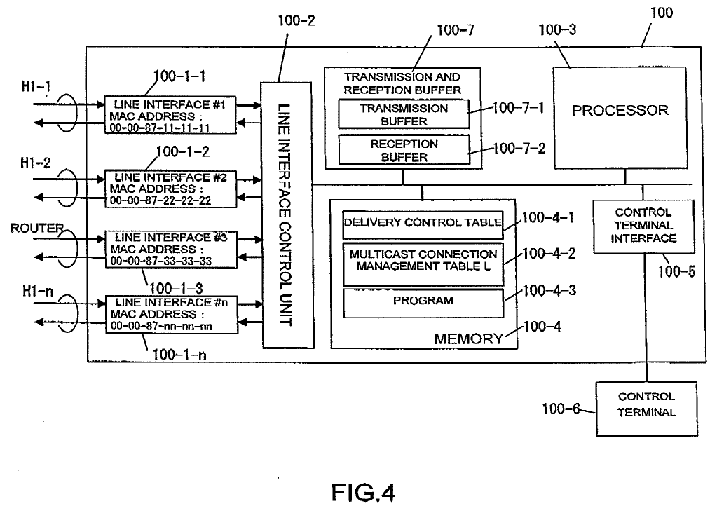

FIG. 4 shows an internal diagram of the layer 2 switch (100) according to this embodiment. Functions of the layer 2 switch not directly related to this embodiment are omitted as appropriate. The layer 2 switch (100) includes line interfaces (100-1-1 to 100-1-n) for plural input and output lines, a line-interface control unit (100-2) that controls the line interfaces (100-1-1 to 100-1-n), a processor (100-3) that performs analysis, editing, and the like of a packet, a memory (100-4) that the processor (100-3) uses to perform processing, a control terminal interface (100-5) that performs interface with an external control terminal (100-6), and a transmission and reception buffer (100-7) that temporarily stores a packet to be transmitted and received. In the memory (100-4), for example, a program (100-4-3) executed by the processor (100-3), a delivery control table (100-4-1) for controlling delivery of multicast data to the user terminals (H1-1 to H1-n) connected subordinately to the layer 2 switch (100), and a multicast connection management table L (100-4-2) for managing multicast connection to the router (200) are stored. The transmission and reception buffer (100-7) has a transmission buffer (100-7-1) and a reception buffer (100-7-2).

Individual MAC addresses are allocated to the line interfaces (100-1-1 to 100-1-n), respectively. In this example, it is assumed that MAC addresses 00-00-87-11-11-11, 00-00-87-22-22-22, 00-00-87-33-33-33, and 00-00-87-nn-nn-nn are allocated to a line interface #1 (100-1-1), a line interface #2 (100-1-2), a line interface #3 (100-1-3), and a line interface #n (100-1-n), respectively.

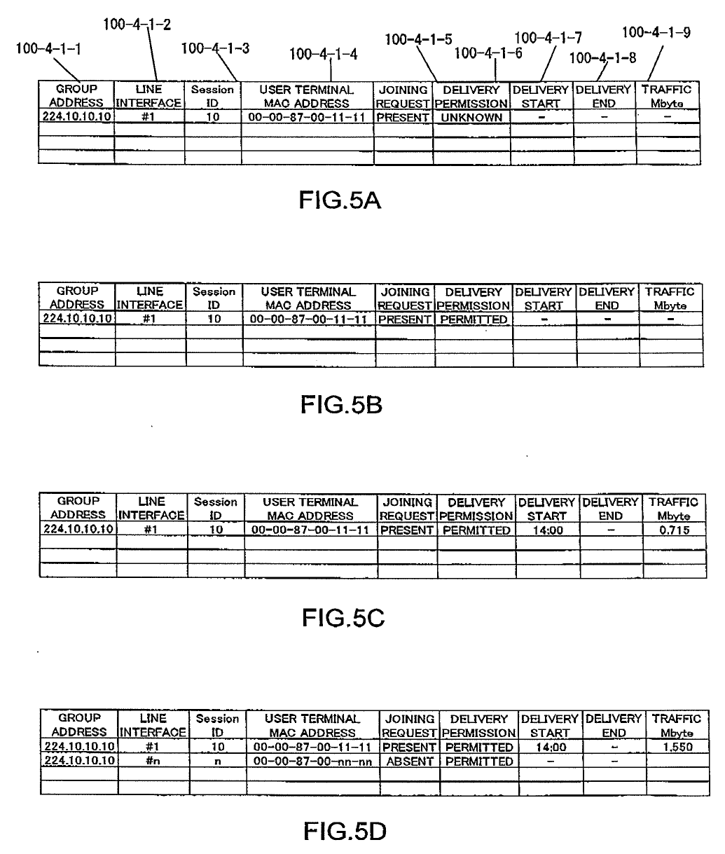

FIG. 5A shows an example of a detailed structure of the delivery control table (100-4-1).

The delivery control table (100-4-1) is a table for managing to which multicast group the user terminals (H1-1 to H1-n) connected subordinately to the layer 2 switch belong and managing presence and absence of a joining request, permission and rejection of delivery, records of delivery time and traffic, and the like. The delivery control table (100-4-1) includes a group address (100-4-1-1), a line interface ID (100-4-1-2), a session ID (100-4-1-3), a user terminal MAC address (100-4-1-4), presence or absence (reception or non-reception) of a joining request (100-4-1-5), delivery permission information (delivery permission or delivery rejection or unknown) (100-4-1-6), a delivery start time (100-4-1-7), a delivery end time (100-4-1-8), and traffic information (100-4-1-9). FIGS. 5B to 5D, FIGS. 6A to 6C, and FIGS. 22A and 22B are diagrams showing updated versions of the delivery control table (100-4-1).

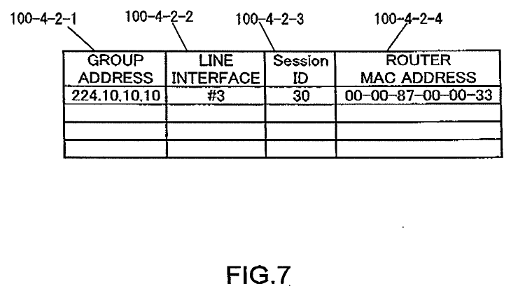

FIG. 7 shows an example of a detailed structure of the multicast connection management table L (100-4-2).

The multicast connection management table L (100-4-2) is a table for managing, for example, a packet of which group address is transmitted and received using which connection to and from the router (200). The multicast connection management table L (100-4-2) includes a group address (100-4-2-1), a line interface ID (100-4-2-2), a Session ID (100-4-2-3), and a router MAC address (100-4-2-4).

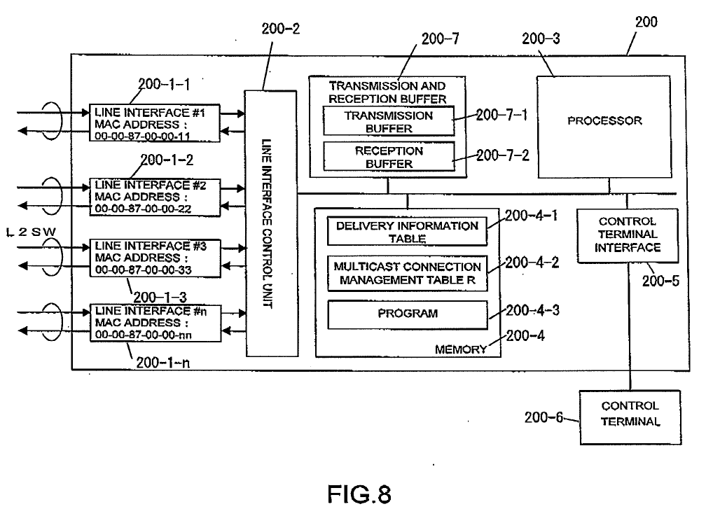

FIG. 8 shows an internal diagram of the router (200) according to this embodiment. Functions of the router not directly related to this embodiment are omitted as appropriate.

The router (200) includes line interfaces (200-1-1 to 200-1-n) for plural input and output lines, a line-interface control unit (200-2) that controls the line interfaces (200-1-1 to 200-1-n), a processor (200-3) that performs analysis, editing, and the like of a packet, a memory (200-4) that the processor (200-3) uses to perform processing, a control terminal interface (200-5) that performs interface with an external control terminal (200-6), and a transmission and reception buffer (200-7) that temporarily stores a packet to be transmitted and received.

In the memory (200-4), for example, a program (200-4-3) executed by the processor (200-3), a delivery information table (200-4-1) for managing the user terminals (H1-1 to H1-n) connected subordinately to the router (200), and a multicast connection management table R (200-4-2) for multicast connection between the layer 2 and the switch (100) are stored. The transmission buffer (200-7) has a transmission buffer (200-7-1) and a reception buffer (200-7-2).

Individual MAC addresses are allocated to the line interfaces (200-1-1 to 200-1-n), respectively. In this example, it is assumed that MAC addresses 00-00-87-00-00-11, 00-00-87-00-00-22, 00-00-87-00-00-33, and 00-00-87-00-00-nn are allocated to a line interface #1 (200-1-1), a line interface #2 (200-1-2), a line interface #3 (200-1-3), and a line interface #n (200-1-n), respectively.

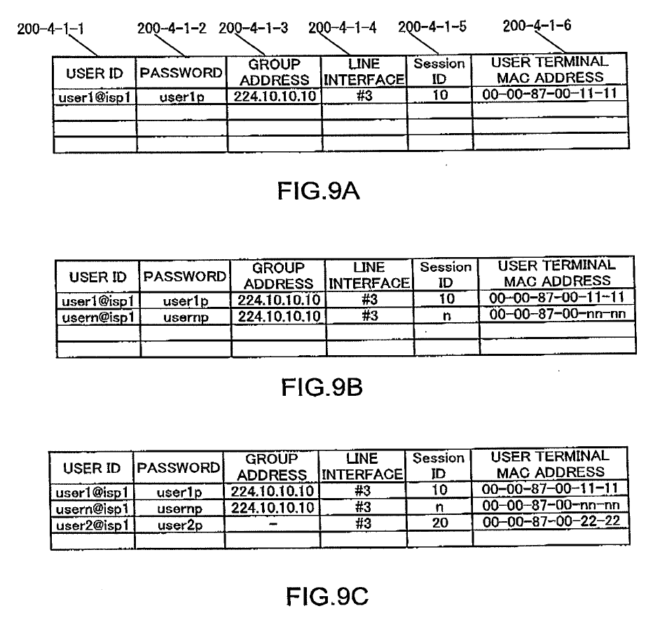

FIG. 9A shows an example of a detailed structure of the delivery information table (200-4-1).

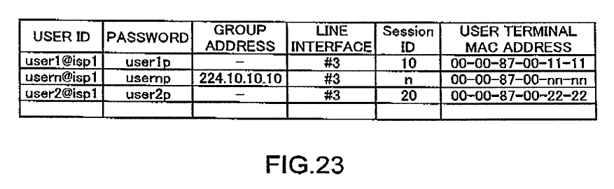

The delivery information table (200-4-1) is a table for managing, for example, information that the router (200) requires for an exchange of information with the authentication and accounting server (S2). The delivery information table (200-4-1) includes a user ID (200-4-1-1), a password (200-4-1-2), a group address (200-4-1-3), a line interface ID (200-4-1-4), a session ID (200-4-1-5), and a user terminal MAC address (200-4-1-6). FIGS. 9B and 9C and FIG. 23 are diagrams showing updated versions of the delivery information table (200-4-1).

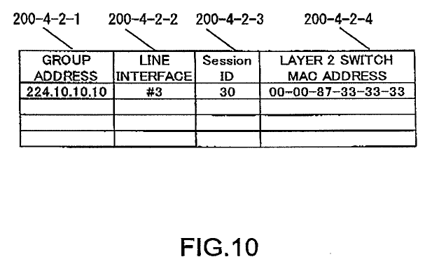

FIG. 10 shows an example of a detailed structure of the multicast connection management table R (200-4-2).

The multicast connection management table R (200-4-2) is a table for managing, for example, a packet of which group address is transmitted and received using which connection to and from the layer 2 switch (100). The multicast connection management table R (200-4-2) includes a group address (200-4-2-1), a line interface ID (200-4-2-2), a Session ID (200-4-2-3), and a layer 2 switch MAC address (200-4-2-4).

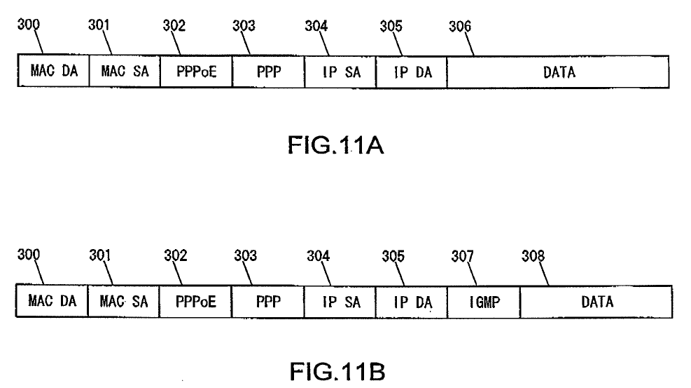

FIG. 11A shows an example of the structure of a packet other than a multicast packet transmitted and received between the user terminal (H1-1 to H1-n) and the router (200).

The packet other than the multicast packet includes a MAC DA (300) as a transmission destination physical address, a MAC SA (301) as a transmission source physical address, PPPoE header information (302), PPP header information (303), an IP SA (304) as a transmission source IP address, an IP DA (305) as a transmission destination IP address, and data (306).

FIG. 11B shows an example of the structure of the multicast packet transmitted and received between the user terminal (H1-1 to H1-n) and the router (200).

In the multicast packet, IGMP (307) as multicast control information is given to the structure of the packet described above. Between the layer 2 switch (100) and the router (200), information of the user management tables (100-4-1 and 200-4-1) managed by the respective apparatuses is given.

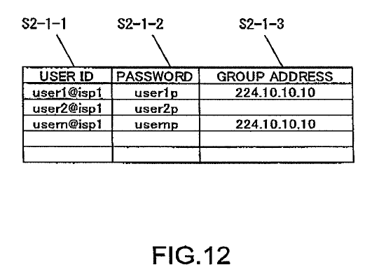

FIG. 12 shows an example of a detailed structure of a user management table held by the authentication and accounting server (S2).

The user management table is used, for example, during PPP connection authentication. The user management table includes a user ID (S2-1-1), a password (S2-1-2), and a group address (S2-1-3). This table can be registered and updated for user identification and user management by an ISP (Internet Service Provider).

### 1.2 Operations

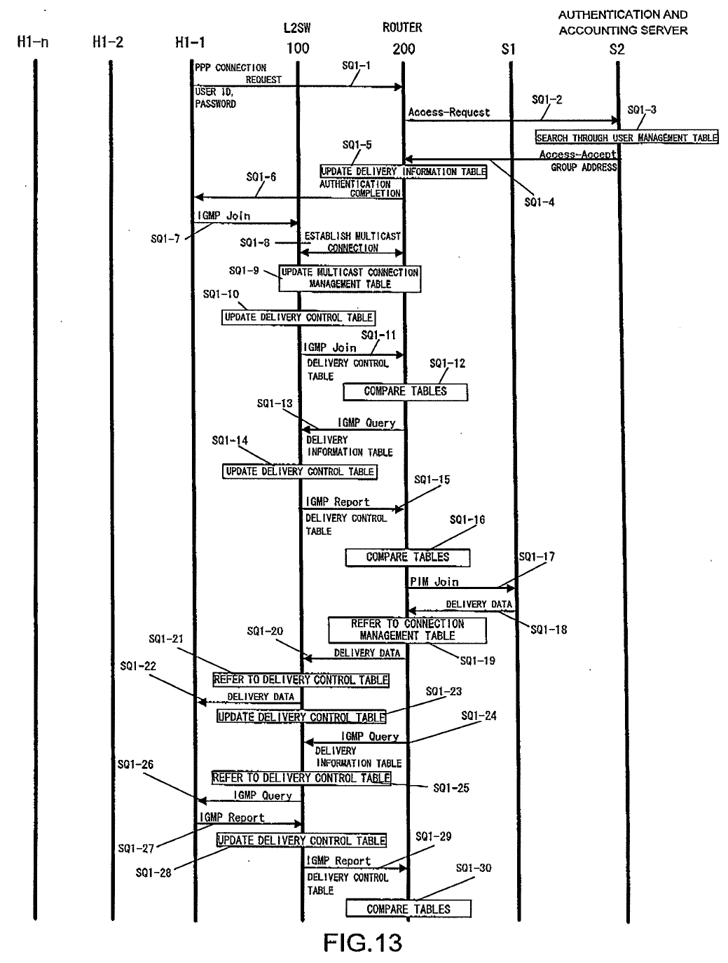

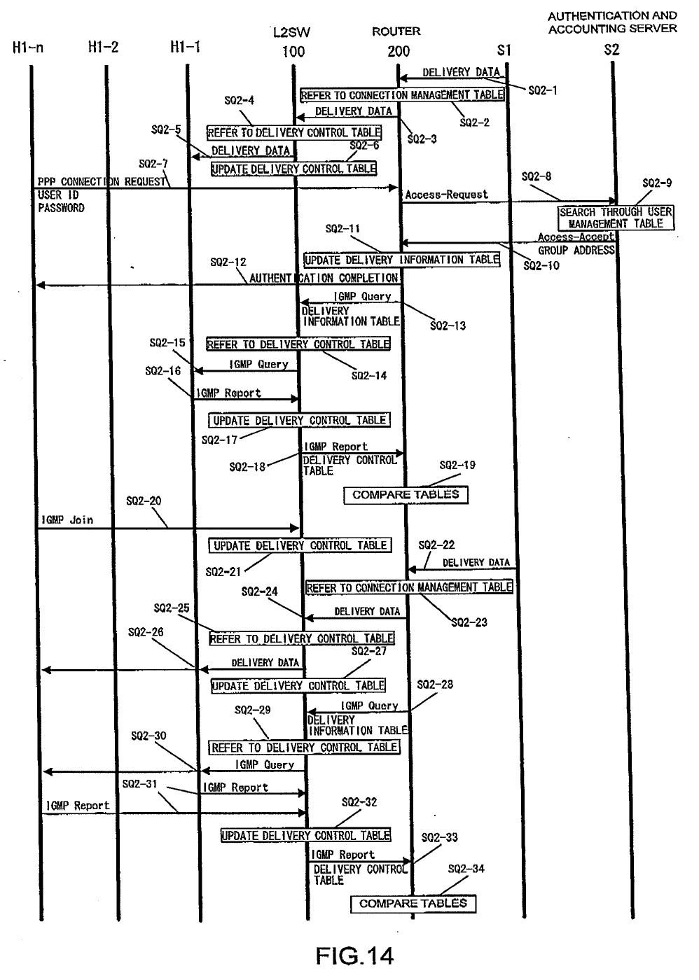

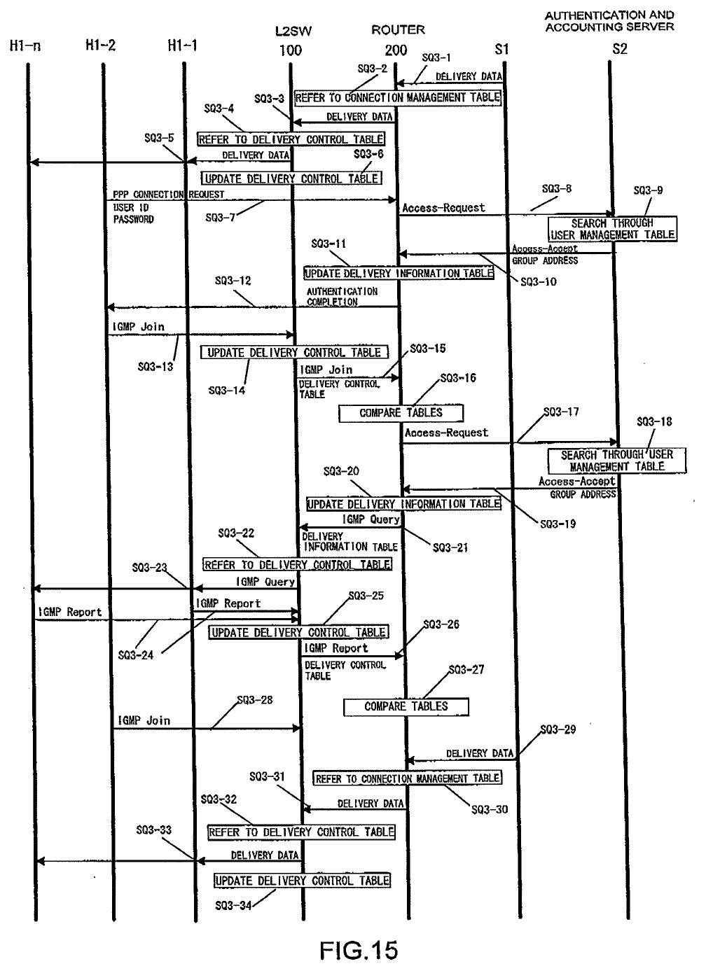

FIG. 13 shows an operation sequence from a PPP connection request of the user terminal (H1-1) having a joining qualification until the user terminal (H1-1) receives data of multicast. An operation sequence from a PPP connection request of the user terminal (H1-n) having a joining qualification until the user terminal (H1-n) receives data of multicast when the user terminal (H1-1) is receiving the multicast data is shown in FIG. 14. An operation sequence from a PPP connection request of the user terminal (H1-2) not having a joining qualification until a multicast joining request is rejected when the user terminals (H1-1 and H1-n) are receiving the multicast data is shown in FIG. 15.

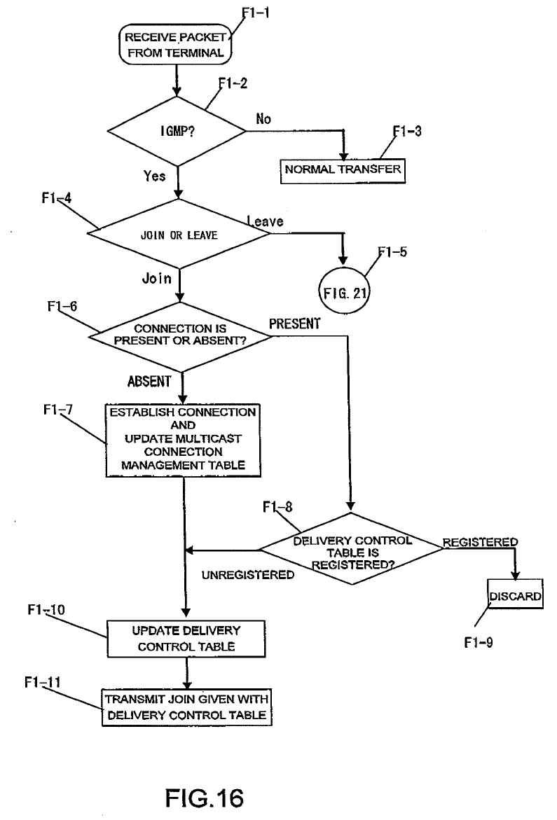

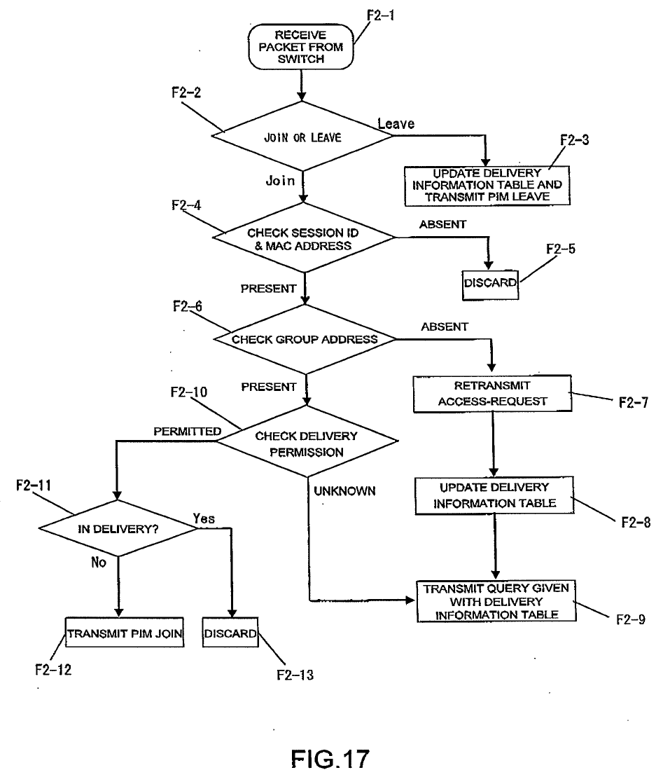

A processing flow of processing performed by the layer 2 switch (100) when the layer 2 switch (100) receives packets from the user terminals (H1-1 to H1-n) connected subordinately to the layer 2 switch (100) is shown in FIG. 16. A processing flow of processing performed by the router (200) when the router (200) receives a packet from the layer 2 switch through a multicast connection (LM) is shown in FIG. 17.

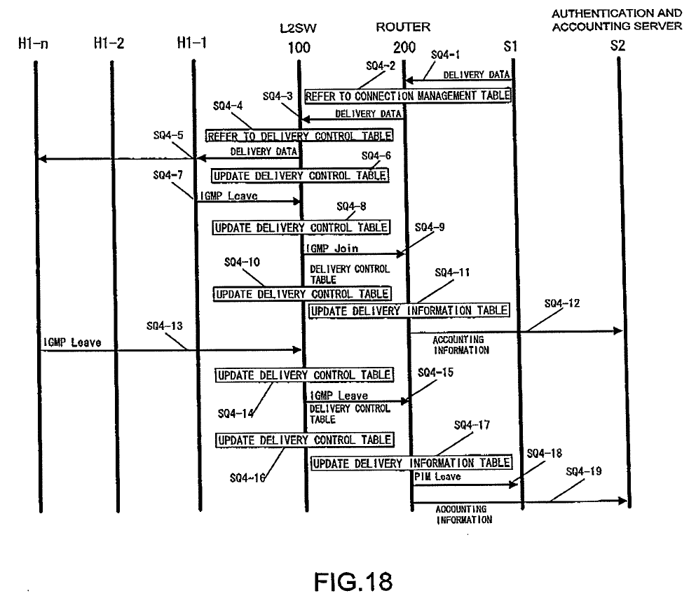

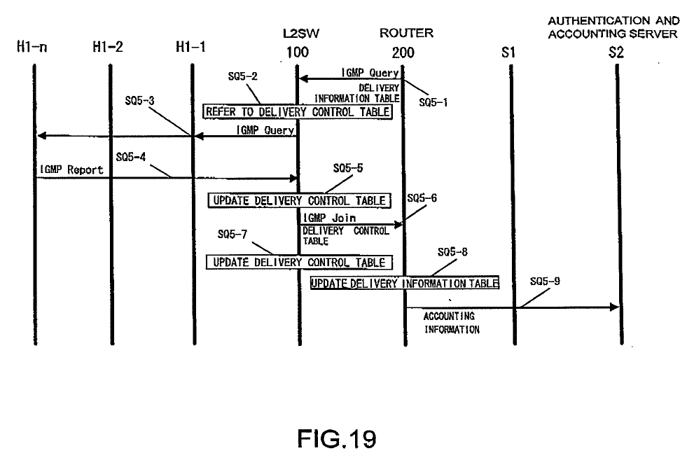

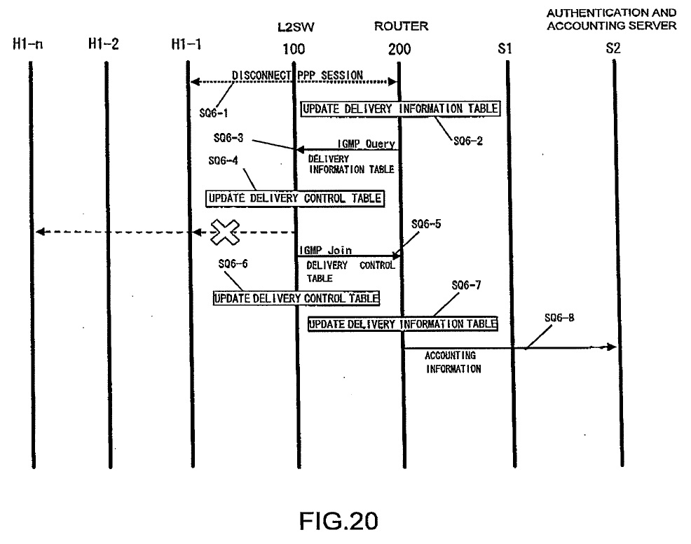

An accounting operation sequence of an accounting operation performed when the user terminals (H1-1 and H1-n) joining a multicast service transmit Leave packets and leave the multicast service is shown in FIG. 18. An accounting operation sequence of an accounting operation performed when the user terminal (H1-1) joining a multicast service does not return a Report packet and leave the multicast service is shown in FIG. 19. An accounting operation sequence of an accounting operation performed when the user terminal (H1-1) joining a multicast service leaves the multicast service because of PPP session disconnection is shown in FIG. 20.

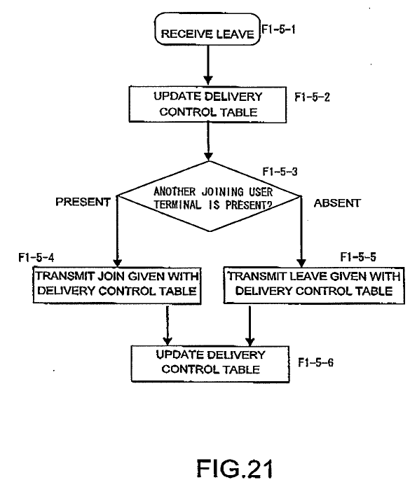

A processing flow of processing performed when the layer 2 switch (100) receives Leave packets from the user terminals (H1-1 to H1-n) is shown in FIG. 21.

(Multicast Service Authentication Method)

First, for example, a flow until the user terminal (H1-1) having a qualification for joining a multicast service of a group address 224.10.10.10 receives delivery data from the delivery server (S1) is explained with reference to FIG. 13.

The user terminal (H1-1) makes a PPP connection request to the router (200) (SQ1-1). At this point, the user terminal (H1-1) transmits a user ID (user1@isp1) and a password (user1p) of the user terminal (H1-1) necessary for connection authentication. The PPP connection request may include a MAC address of the user terminal (H1-1). The router (200) receives the request and transmits an authentication request (Access-Request) including information from the user terminal (H1-1) to the authentication and accounting server (S2) (SQ1-2). The authentication and accounting server (S2) searches through, on the basis of a combination of the received user ID and password, the user management table (FIG. 12) managed by the authentication and accounting server (S2) to judge whether there is a combination of a user ID and a password same as the combination of the received user ID and password (SQ1-3). When there is such a combination of a user ID and a password, the authentication and accounting server (S2) acquires a group address corresponding to the combination (here, 224.10.10.10) and transmits access permission notification (Access-Accept) for Internet connection to the router (200) (SQ1-4). In the user management table (FIG. 12) of the authentication and accounting server (S2), the group address (S2-1-3) of multicast that users can join is also recorded. The access permission notification (Access-Accept) and the group address are transmitted to the router (200).

The router (200) receives the access permission notification (Access-Accept). In the router (200), the processor (200-3) reads out a packet stored in the reception buffer (200-7-2) and updates the delivery information table (200-4-1) (FIG. 9A, SQ1-5). The user ID, user1@isp1, of the user terminal (H1-1) is registered in the user ID (200-4-1-1). The password, user1p, of the user terminal (H1-1) is registered in the password (200-4-1-2). The group address 224.10.10.10 received from the authentication and accounting server (S2) is registered in the group address (200-4-1-3). An ID, for example, #3, of a line interface connected to the layer 2 switch (100) is registered in the line interface (200-4-1-4). An ID, for example, 10, of a session with the layer 2 switch (100) is registered in the Session ID (200-4-1-5). The MAC address, 00-00-87-00-11-11 of the user terminal (H1-1) is registered in the user terminal MAC address (200-4-1-6).

A user terminal MAC address may be included in a PPP connection request. Alternatively, it is also possible that the authentication and accounting server (S2) stores the user terminal MAC address in association with a user ID and includes the user terminal MAC address in access permission notification, whereby the router (200) acquires the user terminal MAC address. The user terminal MAC address may be appropriate terminal identification information for identifying a user terminal. For example, the user terminal MAC address may be a user ID.

The router (200) notifies the user terminal (H1-1) that the authentication is completed (SQ-6). Consequently, the user terminal (H1-1) can perform Internet connection.

Thereafter, the user terminal (H1-1) transmits IGMP Join (a first joining request) in order to join the multicast service with the group address 224.10.10.10 (SQ1-7). The user terminal (H1-1) can acquire a group address of multicast in advance. IGMP Join to be transmitted is, for example, a packet that includes a group address set in advance and terminal identification information of a user terminal and for which the user terminal is set as a transmission destination (i.e., a delivery destination of multicast data). The IGMP Join packet is received by, for example, the line interface #1 (100-1-1) of the layer 2 switch (100) to which the user terminal (H1-1) is connected. The line-interface control unit (100-2) stores the IGMP Join packet in the reception buffer (100-7-2) and notifies the processor (100-3) that the packet is received. The processor (100-3) receives the notification and performs processing described below in accordance with a flow shown in FIG. 16.

The processor (100-3) of the layer 2 switch (100) receives a packet from the user terminal (H1-1) (FIG. 16: F1-1) and discriminates whether the received packet is an IGMP packet (F1-2). When the packet is not an IGMP packet (F1-2), the processor (100-3) stores the packet in the transmission buffer (100-7-1) and performs normal transfer processing (F1-3). For example, the line-interface control unit (100-2) transmits the packet stored in the transmission buffer (100-7-1) through the line interface #3 (100-1-3) on the basis of the MAC DA (300), which is a transmission destination physical address of the packet. Usually, the MAC DA (300) as the transmission destination physical address is 00-00-87-00-00-33 and is addressed to the router (200). The normal processing is applied to the packet during the PPP connection request.

On the other hand, when the received packet is an IGMP packet (F1-2), the processor (100-3) discriminates whether the packet is Join (Report) or Leave (F1-4). When the packet is Leave, the processor (100-3) advances the processing in a flow shown in FIG. 21 (F1-5), although details are described later. When the packet is Join, the processor (100-3) checks, with reference to the multicast connection management table (100-4-2), whether a connection is formed between a group address, which is set in the transmission destination IP address (IP DA) (305) of the packet, and the router (200) (F1-6).

When a connection is not formed (when the relevant group address is not stored) (F1-6), the processor (100-3) forms a multicast connection with the router (200) and reflects a result of forming a multicast connection on the multicast connection management table (100-4-2) (F1-7, SQ1-8, and SQ1-9). FIG. 7 is an example of the table after the reflection. At this point, the multicast connection management table (200-4-2) of the router (200) is also updated. FIG. 10 is an example of the table after the update. Thereafter, the processor (100-3) shifts to processing F1-10.

On the other hand, when a connection is already formed (when the relevant group address is stored (F1-6), the processor (100-3) checks whether the connection is already registered in the delivery control table (100-4-1) using the MAC address of the user terminal (H1-1), which is MAC DA (301) as the transmission source physical address of the packet, as a search key (F1-8). When the connection is already registered in the delivery control table (100-4-1), the processor (100-3) discards the packet from the reception buffer (100-7-2) (F1-9). On the other hand, when the connection is not registered in the deliver control table (100-4-1), the processor (100-3) shifts to processing F1-10.

In the processing F1-10, the processor (100-3) updates the delivery control table (100-4-1) as shown in FIG. 5A (F1-11 and SQ-10). At this point, since delivery permission (100-4-1-6) is unknown, the processor (100-3) sets, for example, “unknown” in the delivery permission (100-4-1-6).

Finally, the processor (100-3) gives information of the updated delivery control table (100-4-1) to a data region (308) of a Join packet (a second joining request), rewrites the MAC SA (301) as the transmission source physical address with 00-00-87-33-33-33 as the MAC address of the line interface #3, and stores 00-00-87-33-33-33 in the transmission buffer (100-7-1). The line-interface control unit (100-2) transmits, on the basis of the MAC DA (300) as the transmission destination physical address of the packet, the Join packet from the transmission buffer (100-7-1) to the router (200) through the line interface #3 (100-1-3) (F1-11 and SQ1-11). However, information concerning the line interface (100-4-1-2) of the delivery control table (100-4-1) does not have to be included in the information to be given.

When the Join packet given with the information of the delivery control table (100-4-1) arrives at the line interface #3 of the router (200), the Join packet is stored in the reception buffer (200-7-2) in the same manner as the storage in the layer 2 switch (100). Processing of the processor (200-3) after the reception of the packet is advanced in a flow shown in FIG. 17.

The processor (200-3) of the router (200) receives the packet (F2-1) and discriminates whether the packet is Join or Leave (F2-2) When the packet is Leave, the processor (200-3) updates the delivery information table (200-4-1), although details are described later, and transmits PIM Leave as a delivery stop request to the delivery server (S1) (F2-3).

When the packet is Join, the processor (200-3) compares information of the delivery control table (FIG. 5A) given to the packet and the delivery information table (FIG. 9A) managed by the router (200) (SQ1-11). Specifically, first, the processor (200-3) searches through the delivery information table (200-4-1) to find whether a combination of the Session ID (100-4-1-3) and the user terminal MAC address (100-4-1-4) based on the delivery control table (100-4-1) is present in the delivery information table (200-4-1) (F2-4). Any one of the Session ID (100-4-1-3) and the user terminal MAC address (100-4-1-4) may be present in the delivery information table (200-4-1). When there is no relevant combination, the processor (200-3) discards the packet (F2-5). When there is a relevant combination, the processor (200-3) judges whether the group address (100-4-1-1) corresponds to the group address (200-4-1-3) of the delivery information table (200-4-1) (F2-6).

When the group address (100-4-1-1) does not correspond to the group address (200-4-1-3) (F2-6), the processor (200-3) retransmits the authentication request (Access-Request) to the authentication and accounting server (S2) using the user ID (200-4-1-1) and the password (200-4-1-2) corresponding to the Session ID (200-4-1-5) and the user terminal MAC address (200-4-1-6) of the delivery information table (200-4-1) (F2-7) and checks latest group address information. The processor (200-3) updates the delivery information table (200-4-1) (F2-8) and gives information of the updated delivery information table (200-4-1) to the data region (308) of a Query packet. The processor (200-3) rewrites the MAC SA (301) as the transmission source physical address with 00-00-87-00-00-33 as the MAC address of the line interface #3 and rewrites the MAC DA (300) as the transmission destination physical address with 00-00-87-33-33-33 recorded in the layer 2 switch MAC address (200-4-2-4) in FIG. 10, and stores the Query packet in the transmission buffer (200-7-1) The line-interface control unit (200-2) transmits the Query packet from the transmission buffer (200-7-1) through the line interface #3 on the basis of the MAC DA (300) of the packet (F2-9). At this point, the group address (200-4-1-3), the Session ID (200-4-1-5), and the user terminal MAC address (200-4-1-6) of the delivery information table (200-4-1) are given to the Query packet.

On the other hand, the group address (100-4-1-3) corresponds to the group address (200-4-1-3) of the delivery information table (200-4-1) (F2-6), the processor (200-3) checks the delivery permission (100-4-1-6) based on the received information of the delivery control table (100-4-1) (F2-10). This data is included in the received packet. When delivery permission information is “unknown”, as in the case in which the group address (100-4-1-1) does not correspond to the group address (200-4-1-3), the processor (200-3) transmits the Query packet to which the information of the delivery information table (200-4-1) is given (F2-9 and SQ1-13). The processor (200-3) may transmit appropriate notification indicating delivery permission. When delivery is already “permitted” (F2-10), if data of the group address 224.10.1010 is being delivered to the layer 2 switch (100) (F2-11), the processor (200-3) discards the packet from the reception buffer (200-7-2) (F2-13). If the data is not being delivered (F2-11), the processor (200-3) transmits a delivery request PIM Join with the group address 224.10.10.10 to the delivery server (S1) (F2-12 and SQ1-17).

The layer 2 switch (100) receives the Query packet and transmits the Query packet to a user terminal joining subordinately to the layer 2 switch (100), i.e., a user terminal for which the delivery permission (100-4-1-6) of the delivery control table (100-4-1) is “permitted” and the joining request (100-4-1-5) of the delivery control table (100-4-1) is “present”. After the transmission, the processor (200-3) updates the delivery control table (100-4-1) on the basis of the received information of the delivery information table (200-4-1). Specifically, in the delivery information table (200-4-1) received at this point, 224.10.10.10 is recorded in the group address (200-4-1-4), 10 is recorded in the Session ID (200-4-1-5), and 00-00-87-00-11-11 is recorded in the user terminal MAC address (200-4-1-6).

The processor (100-3) judges that the user terminal included in delivery to the received information of the delivery information table (200-4-1) is permitted. Therefore, as shown in FIG. 5S, the processor (100-3) updates the deliver permission (100-4-1-6) corresponding to the relevant user terminal MAC address of the delivery control table (100-4-1) from “unknown” to “permitted” (SQ1-14). The processor (100-3) gives information of the updated delivery control table (100-4-1) to a Report packet and transmits the Report packet to the router (200) (SQ1-15). As described above, the router (200) compares the tables (SQ1-16) and transmits PIM Join as a data delivery request to the delivery server (S1) (SQ1-17). Data is delivered from the delivery server (S1) (SQ1-18).

The router (200) receives the data, refers to the multicast connection management table (200-4-2) (SQ1-19), and transfers the data to the layer 2 switch (100) in accordance with a line interface ID and the like corresponding to a group address (SQ1-20). The layer 2 switch (100) receives the data, refers to the delivery control table (100-4-1) (SQ1-21), and transfers the data to the user terminal (H1-1) in accordance with a user terminal MAC address, a line interface ID, and the like of an entry in which the joining request (100-4-1-5) is “present” and the delivery permission (100-4-1-6) is “permitted” (SQ-1-22).

At this point, as shown in FIG. 5C, the layer 2 switch (100) records the delivery start time (100-4-1-7) of the delivery control table (100-4-1) and updates the traffic (100-4-1-9) every time the layer 2 switch (100) transfers delivery data (SQ1-23).

A Query packet is periodically transmitted from the router (200) for joining check (SQ1-24). The layer 2 switch (100) refers to the delivery control table (100-4-1) (SQ1-25) and transmits the Query packet to the user terminal (H1-1) (SQ1-26). When the user terminal (H1-1) continues the joining, the user terminal (H1-1) returns a Report packet for requesting the continuation (SQ1-27). The layer 2 switch (100) updates the delivery control table (100-4-1) in accordance with the flow shown in FIG. 16 (SQ1-28) and returns a Report packet to the router (200) (SQ1-29).

The router (200) not only judges necessity of delivery data but also checks the delivery control table (100-4-1) of the layer 2 switch (100) and the delivery information table (100-4-2) of the router (200) (SQ1-30) according to a periodical joining check. In this way, the router (200) can obtain consistency of both the tables.

When the user terminal (H1-1) joins in the multicast service with the group address 224.10.10.10, the user terminal (H1-n) having a joining qualification performs PPP connection and requests joining in the multicast service with the group address 224.10.10.10 and delivery data is transferred to the user terminal (H1-n). A flow of processing in this case is explained with reference to FIG. 14.

Delivery data is transferred from the delivery server (S1) to the router (200) (SQ2-1). In the same manner as described above, the router (200) refers to the delivery information table (200-4-1) (SQ2-2) and transfers the delivery data to the layer 2 switch (100) (SQ2-3). The layer 2 switch (100) refers to the delivery control table (100-4-1) (SQ2-4) and transfers the data to the user terminal (H1-1) (SQ2-5). At this point, the layer 2 switch (100) updates the traffic (100-4-1-9) of the delivery control table (100-4-1) every time the layer 2 switch (100) transfers the data.

The user terminal (H1-n) makes a PPP connection request (SQ2-7). As in the case of the user terminal (H1-1), the router (200) transmits an authentication request (Access-Request) to the authentication and accounting server (S2) (SQ2-8). The authentication and accounting server (S2) searches through the user management table (FIG. 12) (SQ2-9) and returns information concerning a group address that the user terminal (H1-n) can join to the router (200) together with access permission notification (Access-Accept) (AQ2-10). The router (200) updates the delivery information table (200-4-1) on the basis of the information (FIG. 9B, SQ2-11) and notifies the user terminal (H1-n) of completion of the authentication (SQ2-12).

The router (200) transmits a Query packet including respective kinds of information of the delivery information table shown in FIG. 9B to the layer 2 switch (100) to check whether there is a user terminal that joins the group address 224.10.10.10 and maintain consistency of the table with that of the layer 2 switch (100) (SQ2-13). This case is explained below. The router (200) may shift to processing in SQ2-20 described later without transmitting a Query packet. The layer 2 switch (100) refers to the delivery control table (100-4-1) (SQ2-14) and transmits Query to the user terminal (H1-1) (SQ2-15). The user terminal (H1-1) returns a response to Query (SQ2-16). Thereafter, as shown in FIG. 5D, the layer 2 switch (100) updates the delivery control table (100-4-1) (3Q2-17), gives information of the updated delivery control table (100-4-1) to a Report packet, and transmits the Report packet to the router (200) (SQ2-18). In this case, when the router (200) compares the tables (FIG. 5D and FIG. 9B) (SQ2-19), since the group address 224.10.10.10 is already in delivery, after checking consistency of the tables, the router (200) discards the packet (F2-13).

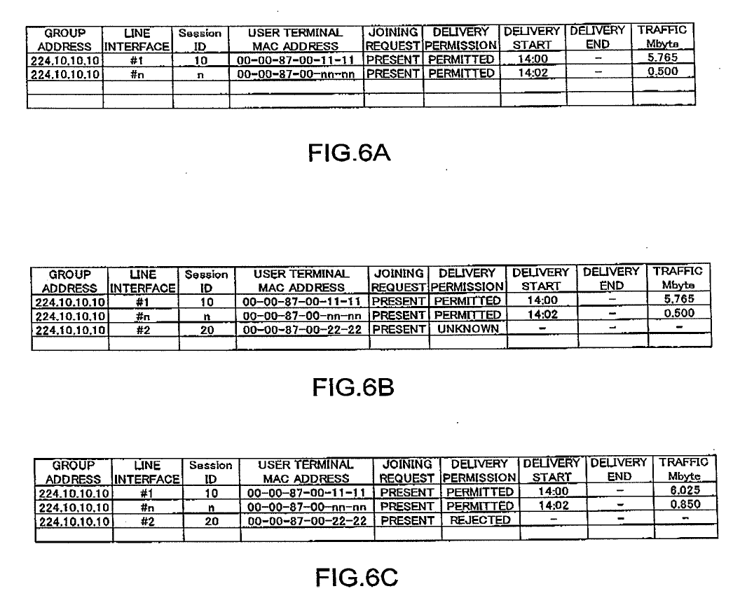

When the user terminal (H1-n) requests joining in the group address 224.10.10.10 (SQ2-20), the layer 2 switch (100) changes the joining request (100-4-1-5) of the delivery control table (100-4-1, FIG. 5D) from “absent” to “present” (SQ2-21). When the delivery control table (100-4-1) is in this state, data is delivered from the delivery server (S1) (SQ2-22). The router refers to the multicast connection management table (200-4-2) in the same manner as the flow shown in FIG. 13 regardless of the fact the user terminals have increased (SQ2-23) and transfers the data to the layer 2 switch (100) (SQ2-24). At this point, in the delivery control table (100-4-1) referred to by the layer 2 switch (100) (SQ2-25), concerning the two user terminals (H1-1 and H1-n), there is information that the joining request (100-4-1-5) is “present” and the delivery permission (100-4-1-6) is “permitted”. Therefore, the layer 2 switch (100) copies the delivery data and transfers the data to the two user terminals (H1-1 and H1-n) (SQ-26). At this point, the delivery control table (100-4-1) is updated as shown in FIG. 6A (SQ2-27).

The delivery control table (100-4-1) shown in FIG. 6A is also referred to (SQ2-29) with respect to a periodical Query packet (SQ2-28) of the router (200). Therefore, the layer 2 switch (100) transmits Query packets to the two user terminals (H1-1 and H1-n) (SQ2-30). The layer 2 switch (100) waits for Report packets as responses from the user terminals (H1-1 and H1-n) for a fixed time (SQ2-31). Thereafter, the layer 2 switch (100) updates the delivery control table (100-4-1) (SQ2-32) (in this case, there is no change in the information even if update processing is performed. However, the update processing is performed to keep consistency with information from the router (200)) and returns a Report packet to the router (200) (SQ2-33). The router (200) compares the tables (SQ2-34) to perform a joining and check consistency of the tables.

Consequently, when a new user terminal makes a joining request for joining an identical group address, if the delivery control table (100-4-1) is updated by the periodical joining check of the router (200), SQ1-12 to SQ1-15 in FIG. 13 can be omitted.

When the user terminals (H1-1 and H1-n) join in the multicast service with the group address 224.10.10.10, the user terminal (H1-2) not having a joining qualification makes PPP connection and requests to join the multicast service with the group address 224.10.10.10, and delivery data is not transferred to the user terminal (H12). A flow in this case is explained with reference to FIG. 15.

Since a flow from the time when data is delivered from the delivery server (S1) until the data is delivered to the user terminals (H1-1 and H1-n) (SQ3-1 to SQ3-5) is the same as that described above, explanation of the flow is omitted. The delivery control table (100-4-1) updated to this point (SQ3-6) is the delivery control table shown in FIG. 6A. When authentication of the user terminal (H1-2) not having a joining qualification for joining the group address 224.10.10.10 is completed after a PPP connection request in the same manner as described above (SQ3-7 to SQ3-12), the delivery information table (200-4-1) of the router (200) changes to a state shown in FIG. 9C.

When a Join packet as a joining request is transmitted from the user terminal (H1-2) (SQ3-13), the delivery control table (100-4-1) is updated as shown in FIG. 6B (SQ3-14). The layer 2 switch (100) gives information concerning the update to the Join packet and transmits the Join packet to the router (200) (SQ3-15). The router (200) compares the tables (FIGS. 6B and 9C) (SQ3-16). In the delivery information table (200-4-2), the group address 224.10.10.10 is not registered in association with a combination of the Session ID (200-4-1-5) “20” and the user terminal MAC address (200-4-1-6) “00-00-87-00-22-22”. Therefore, the router (200) retransmits an authentication request (Access-Request) to the authentication and accounting server (S2) using user2@isp1 of the user ID (200-4-1-1) and user2p of the password (200-4-1-2) (F2-7 and SQ3-17). A group address in which the user terminal (H1-2) has a joining qualification is transmitted to the router (200) together with access permission notification (Access-Accept) as a response to the authentication request (Access-Request) (SQ3-18 and SQ3-19). The router (200) receives the response and updates the delivery information table (200-4-1) (SQ3-20). When there is no group address that the user terminal (H1-2) can join even if the router (200) checks with the authentication and accounting server again, the delivery information table (200-4-1) is not changed from that shown in FIG. 9C.

The router (200) gives information reflecting a result of the recheck to a Query packet and transmits the Query packet to the layer 2 switch (100) (SQ3-21). The layer 2 switch (100) receives the Query packet. The layer 2 switch (100) refers to the delivery control table (100-4-1) at the present point (SQ3-22) and transmits the Query packet to the user terminals (H1-1 and H1-n) that join in the group address and to which data is delivered (SQ3-23). The layer 2 switch (100) waits for Report packets from the user terminals (H1-1 and H1-n) for a fixed time (SQ3-24). Thereafter, the layer 2 switch (100) updates the delivery control table (100-4-1) on the basis of information from the router (200) (SQ3-25, FIG. 6C). In this case, specifically, the delivery permission (100-4-1-6) of the terminal (H1-2) is “unknown” in FIG. 6B. Since there is no group address in the information from the router (200), the layer 2 switch (100) updates the delivery permission (100-4-1-6) to “rejected”. The layer 2 switch (100) gives information of the updated delivery control table (100-4-1) to a Report packet and returns the Report packet to the router (200) (SQ3-26). The router (200) receives the Report packet and checks consistency of the tables (FIGS. 6C and 9) (SQ3-27).

When the delivery control table (100-4-1) of the layer 2 switch (100) is in a state of FIG. 6C, the user terminal (H1-2) transmits a Join packet as a joining request again (SQ3-28). In this case, as in the above case, the delivery control table (100-4-1) is not updated. Therefore, even if data is transmitted from the delivery server (S1), the data can be transferred to only the user terminals (H1-1 and H1-n), the joining request (100-4-1-5) of which is “present” and the delivery permission (100-4-1-6) of which is “permitted (SQ3-29 to SQ3-34). Since the delivery permission is “rejected”, the layer 2 switch (100) discards the Join packet.

Necessity of the rechecking with the authentication and accounting server (S2) by the router (200) is explained. It is assumed that, at a point of the PPP connection request (SQ3-7), in the authentication and accounting server (S2), there is no address that the user terminal (H1-2) can join but information held by the authentication and accounting server (S2) is updated after authentication completion (SQ3-12) and the user terminal (H1-2) is permitted to join the group address 224.10.10.10. In this case, if a PPP connection re-request of the user terminal (H1-2) is not made, the delivery information table (200-4-1) of the router (200) is not updated. Therefore, the router (200) rechecks with the authentication and accounting server (S2) when there is no relevant group address in the information from the layer 2 switch (100).

Further, it is assumed that there is no joining group yet at the time of this rechecking but, thereafter, the information held by the authentication and accounting server (S2) is updated and the user terminal (H1-2) is permitted to join the group address 224.10.10.10. Since the delivery permission (100-4-1-6) of the delivery control table (100-4-1) of the layer 2 switch (100) is “rejected”, the user terminal (H1-2) is not permitted to join the group address even it the user terminal (H1-2) retries the joining request over and over again. Therefore, it is also possible that, when the delivery permission (100-4-1-6) is updated to “rejected”, a valid time (a specified number of times) of information concerning the update is set and, when the valid time (the specified number of times) is exceeded, “rejected” is changed to “unknown”. Consequently, the router (200) has an opportunity of rechecking with the authentication and accounting server (S2).

As described above, the router (200) that cannot grasp a joining request of a user terminal for joining a multicast service does not control permission and rejection but the layer 2 switch (100) receives information concerning the router (200) and periodically checks consistency of the tables. Consequently, it is unnecessary to check authentication with the router (200) or the authentication and accounting server (S2) every time the user terminal makes a joining request and the layer 2 switch (100) can accurately control permission and rejection of the joining request with a necessary minimum authentication check.

### Multicast Service Accounting Method

In the network configuration assumed in this embodiment, since the router does not perform control of transfer of delivery data to the user terminals, the router cannot grasp when a user terminal joins a multicast service and when the user terminal leaves the multicast service. As a result, as in, for example, the technique disclosed in JP-A-2006-148750, the router cannot transmit accounting start notification and accounting end notification to the accounting server with joining and leaving of the user terminals as an opportunity. Therefore, in this embodiment, the layer 2 switch that performs control of transfer of delivery data to the user terminals collects information necessary for accounting and transmits the information to the router with, for example, leaving of a user terminal from a group as an opportunity and the router transfers the information to the accounting server. Consequently, accounting is realized.

The leaving of the user terminal from the group is caused by, for example, three events, i.e., reception of a Leave packet from the user terminal, no response (Report) to a periodical joining check (Query), and disconnection of a PPP session. The leaving may be caused by events other than these events. These events are explained below in order.

First, a flow of processing performed when a Leave packet as a leaving declaration is received from the joining user terminal (H1-1) is explained with reference to FIGS. 18 and 21.

Data is delivered from the delivery server (S1) (SQ4-1). The router (200) refers to the multicast connection management table (200-4-2) (SQ4-1) and transfers the data to the layer 2 switch (100) (SQ4-3). The layer 2 switch (100) refers to a delivery control table (e.g., FIG. 6A) (SQ4-4) and transfers the data to the user terminals (H1-1 and H1-n) (SQ4-5).

A Leave packet as a declaration of leaving the group address 224.10.10.10 is transmitted from the user terminal (H1-1) (SQ4-7). The Leave packet includes a group address and a terminal MAC address. The processor (100-3) of the layer 2 switch (100) receives the Leave packet from the user terminal (H1-1) (F1-5-1) and advances the processing in a flow shown in FIG. 21.

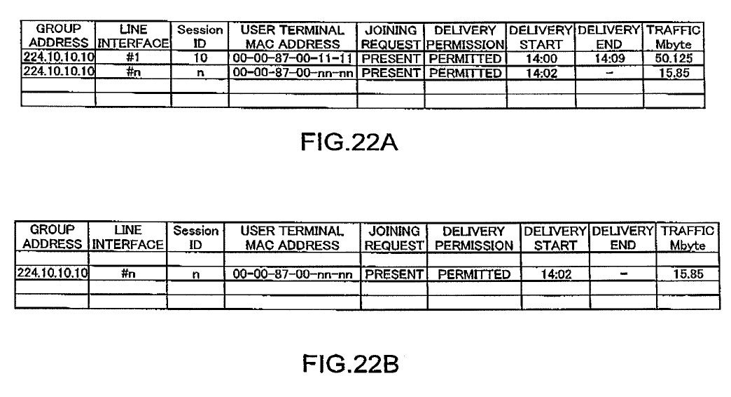

First, the layer 2 switch (100) records the preset time in the delivery end time (100-4-1-8) corresponding to the MAC address of the user terminal (H1-1) of the delivery control table (100-4-1) (F1-5-2 and SQ4-8, FIG. 22A). Subsequently, the layer 2 switch (100) checks whether another user terminal joins in the group address 224.10.10.10 (F1-5-3). When another user terminal (H1-n) joins in the group address 224.10.10.10, the layer 2 switch (100) gives information of the delivery control table (100-4-1) to a Join packet and transmits the Join packet to the router (200) (F1-5-4 and SQ4-9). After the transmission, the layer 2 switch (100) deletes information concerning the user terminal (H1-1), which has left the group address 224.10.10.10, from the delivery control table (100-4-1) (F1-5-6 and SQ4-10, FIG. 22B).

The router (200) receives information in which time is recorded in the delivery end time (100-4-1-8). The router (200) deletes the group address (200-4-1-3) of corresponding user information of the delivery information table (200-4-1) (SQ4-11, FIG. 23). The router (200) transmits the delivery start and end times, the traffic, the group address, and the user ID (200-4-1-1) received from the layer 2 switch (100) to the authentication and accounting server (S2) as accounting information (F2-3 and SQ4-12) A delivery provider can realize accounting from information left in the authentication and accounting server.

After the user terminal (H1-1) leaves the address group 224.10.10.10, the user terminal (H1-n) transmits a Leave packet (SQ4-13). The layer 2 switch (100) updates the delivery control table (100-4-1) in the same manner (SQ4-14). In this case, since there is no other user terminal that joins in the group address 224.10.10.10, the layer 2 switch (100) adds information of the delivery control table (100-4-1) to a Leave packet and transmits the Leave packet (F1-5-5 and SQ4-15). After the transmission, the layer 2 switch (100) deletes information concerning the user terminal (H1-n) from the delivery control table (100-4-1) (F1-5-6 and SQ4-16).

The router 200 receives the Leave packet from the layer 2 switch (100) (SQ4-15). The router 200 deletes the group address of the delivery information table (200-4-1) (SQ4-17) and transmits PIM Leave as a delivery stop request to the delivery server (S2) (SQ4-18). As in the case of the user terminal (H1-1 that left the group address first, the router (200) transmits accounting information of the user terminal (H1-n) to the authentication and accounting server (SQ4-19).

An accounting operation performed when there is no response (Report) of the user terminal (H1-1) to a periodical joining check (Query) is explained with reference to FIG. 19.

First, the router (200) transmits a Query packet as a joining check to the layer 2 switch (100) (SQ5-1). The layer 2 switch (100) receives the Query packet. The layer 2 switch refers to the delivery control table (100-4-1) (SQ5-2) and transmits the Query packet to the user terminals (H1-1 and H1-n) (SQ5-3). When a Report packet indicating continuation of joining is not returned from the user terminals (H1-1 and H1-n) within a fixed time (SQ5-4), the layer 2 switch (100) judges that the user terminals have left a group address and performs processing same as that performed when the Leave packet is received. For example, the layer 2 switch (100) updates the delivery control table (100-4-1) (SQ5-5, FIG. 22A), transmits information concerning the update to the router (200) (SQ5-6), and deletes user information (SQ5-7, FIG. 22B)). The router (200) transmits accounting information to the authentication and accounting server (S2) in the same manner. In this way, even when there is no response (Report) to the joining check (Query) from the user terminals, it is possible to realize accounting (SQ5-8 and SQ5-9).

If a function of a normal multicast router for judging that a user terminal has left a group address when time during which the layer 2 switch (100) waits for a Report packet exceeds a specified time or when a Report packet is not returned continuously for plural times is given to the layer 2 switch (100), the layer 2 switch (100) can cope with environments such as service contents, an accounting method, and the number of user terminals.

An accounting operation performed when the user terminal (H1-1) leaves a group address because of PPP session disconnection is explained with reference to FIG. 20.

In the network configuration assumed in this embodiment, when a PPP session is disconnected, a multicast service performed on the session cannot be continued.

When a PPP session between the user terminal (H1-1) and the router (200) is disconnected (SQ6-1), the router (200) updates the delivery information table (200-4-1) as shown in FIG. 23 (SQ6-2). The router (200) gives information after the update to a Query packet and transmits the Query packet to the layer 2 switch (100) (SQ6-3).

The layer 2 switch (100) judges that the user terminal (H1-1), the PPP session of which is disconnected, is “rejected” in the delivery permission (100-4-1-6), records the delivery end time (100-4-1-8) of the delivery control table (100-4-1) (SQ6-4, FIG. 22A), and transmits information concerning the recording of the delivery end time (SQ6-5). Thereafter, the layer 2 switch (100) deletes the information concerning the user terminal (H1-1) from the delivery control table (100-4-1) (SQ6-6, FIG. 22B). At this points usually, the layer 2 switch (100) receives the Query packet from the router (200) and transmits the Query packet to the user terminals (H1-1 and H1-n) with reference to the delivery control table (100-4-1) before updating the delivery control table (100-4-1). However, when the user terminal (H1-1) joining in the group address is rejected by the Query packet, the layer 2 may update the delivery control table (100-4-1) and transmits information concerning the update to the router (200).

As described above, the layer 2 switch (100), rather than the router (200), collects information necessary for accounting and transmits the information to the authentication and accounting server through the router (200). Consequently, it is possible to realize accounting.

Prepaid accounting according to time is also possible. In the prepaid accounting according to time, for example, a term of validity is set in the group address (200-4-1-3) of the delivery information table (200-4-1) of the router (200) and information concerning the term of validity is transmitted to the layer 2 switch (100) together with data, whereby the layer 2 switch (100) stops transfer of the delivery data when the term of validity expires. Moreover, prepaid accounting according to traffic is also possible. In the prepaid accounting according to traffic, for example, traffic is set instead of the term of validity and transfer of the delivery data is stopped when traffic exceeds the set traffic.

### 2. Second Embodiment

In a second embodiment of the present invention, control of delivery data involving authentication is performed in the same manner as the first embodiment.

### Multicast Service Accounting Method

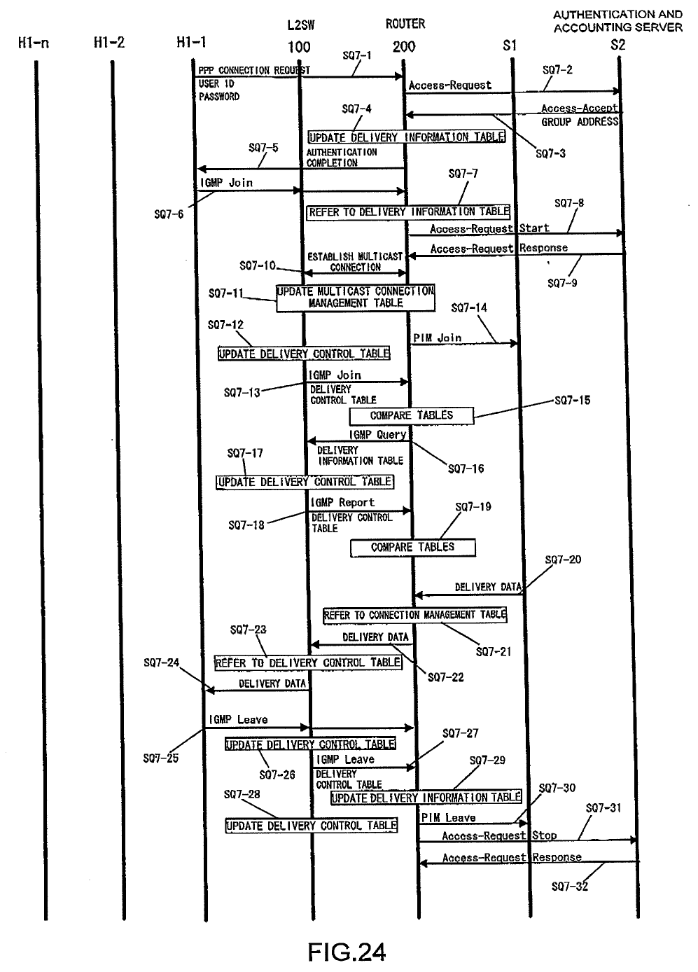

FIG. 24 shows an accounting operation sequence according to the second embodiment.

In the first embodiment, an IGMP packet from the user terminal is terminated by the layer 2 switch. However, in the second embodiment, the layer 2 switch does not terminate but snoops the IGMP packet.

A flow of an accounting operation performed when the user terminal (H1-1) having a joining qualification for joining the multicast service with the group address 224.10.10.10 receives delivery data from the delivery server (S1) and leaves the group address with a leaving declaration (Leave) is explained with reference to FIG. 24.

Operations from the time when the user terminal (H1-1) having a joining qualification for joining the group address 224.10.10.10 makes a PPP connection request until the user terminal (H1-1) receives an authentication completion notice from the router (200) (SQ7-1 to SQ7-5) are the same as those in the first embodiment. After completion of PPP connection, the user terminal (H1-1) transmits a Join packet (SQ7-6). The layer 2 switch (100) snoops content of the Join packet and transfers the Join packet to the router (200). The Join packet includes a group address and an MAC address of the user terminal (H1-1). The layer 2 switch (100) advances to the processing in the same manner as the first embodiment in accordance with the flow shown in FIG. 16 on the basis of snooped information (SQ7-10 to SQ7-13).

On the other hand, the router (200) receives the Join packet transferred by the layer 2 switch (100). The router (200) refers to the delivery information table (200-4-1) (SQ7-7) and transmits accounting start notification (Access-Request-Start) to the authentication and accounting server (S2) (SQ7-8). The accounting start notification includes the group address and the MAC address of the user terminal (H1-1). The authentication and accounting server (S2) records, for example, for each MAC address of terminals, time when the accounting start notification is received and returns a response (Access-Request-Response) to the router (200) (SQ7-9). The router (200) transmits a delivery request (PIM Join) to the delivery server (S1) (SQ7-14).

The router (200) receives the Join packet from the layer 2 switch (100) through the multicast connection (LM). The router (200) advances the processing in the same manner as the first embodiment in accordance with the flow shown in FIG. 17 and obtains consistency of user information managed by the respective apparatuses (SQ7-15 to SQ7-17). According to the delivery request from the router (200) (SQ7-14), the delivery data is transferred to the user terminal (H1-1) in the same manner as the first embodiment (SQ7-20 to SQ7-24). In this embodiment, the router (200) receives Join from the user terminal. However, for example, it is also possible that the router (200) transmits the delivery data to the layer 2 switch (100) through the multicast connection established between the router (200) and the layer 2 switch (100) and the layer 2 switch (100) copies the data and delivers the data to the user terminal (H1-1).

When the user terminal (H1-1) joining in the group address 224.10.10.10 transmits a Leave packet (SQ7-25), the layer 2 switch (100) snoops content of the Leave packet and transfers the Leave packet to the router (200). The Leave packet includes the group address and the MAC address of the user terminal (H1-1). The layer 2 switch (100) advances the processing in the same manner as the first embodiment in accordance with the flow shown in FIG. 21 on the basis of snooped information (SQ7-26 to SQ7-28).

On the other hand, the router (200) receives the Leave packet transferred by the layer 2 switch (100), updates the delivery information table (200-4-1) (SQ7-29), and transmits accounting end notification (Access-Request-Stop) to the authentication and accounting server (S2) (SQ7-31). The accounting end notification includes the group address and the MAC address of the user terminal (H1-1). The router (200) transmits a delivery stop request (PIM Leave) to the delivery server (S1) (SQ7-30). The authentication and accounting server (S2) records the accounting end notification and returns a response (Access-Request-Response) to the router (200) (SQ7-32).

According to the processing described above, the authentication and accounting server (S2) can grasp time when the user terminal (H1-1) joins the group address 224.10.10.0 and time when the user terminal (H1-1) leaves the group address 224.10.10.10. A delivery provider can realize accounting of the multicast service. For example, it is possible to realize accounting for each user terminal and accounting corresponding to a group address.

When the router (200) transmits the accounting end notification, it is possible to realize more accurate accounting and metered accounting by giving the accounting information received from the layer 2 switch (100) (SQ7-27) to the accounting end notification.

The present invention can be applied to various systems such as IPv6 and MLD. The present invention may be applied to not only the layer 2 switch but also any apparatus as long as the apparatus is a communication apparatus such as a BAS (Broadband Access Server) that can be installed with the respective means and is arranged between a router and user terminals. Moreover, in the present invention, other than the router, an appropriate packet transfer apparatus can be adopted as long as the packet transfer apparatus performs multicast delivery.

What is claimed is:

1. A network system comprising:
a first packet transfer apparatus that terminates plural user terminals, copies received multicast data, and transfers the multicast data to each of the user terminals;
a second packet transfer apparatus that communicates with the plural user terminals point to point through the first packet transfer apparatus; and
a server that outputs a group address of a multicast group that the user terminal can join to the second packet transfer apparatus,
wherein
the first packet transfer apparatus includes a delivery control table in which entries including a group address, terminal identification information of the user terminal and information indicating delivery permission or delivery rejection are stored,
the second packet transfer apparatus receives a connection request for point to point connection from the user terminal and acquires the group address of the multicast group that the user terminal can join from the server,
the second packet transfer apparatus stores the acquired group address and the terminal identification information of the user terminal in association with each other,
the first packet transfer apparatus receives, from the user terminal, a first joining request that is for joining a multicast group and includes the group address set in advance and the terminal identification information of the user terminal and is set the user terminal as a transmission source, terminates the first joining request, and stores the group address and the terminal identification information in the delivery control table in association with each other,
the first packet transfer apparatus transmits a second joining request that includes the received group address and terminal identification information and is set the first packet transfer apparatus itself as a transmission source to the second packet transfer apparatus,
the second packet transfer apparatus compares the group address and the terminal identification information included in the second joining request and the stored group address and the stored terminal identification information, and transmits, to the first packet transfer apparatus, notification indicating delivery permission when the group address and terminal identification information coinciding with the group address and the terminal identification information included in the second joining request are stored, and notification indicating delivery rejection when the group address and terminal identification information coinciding with the group address and the terminal identification information included in the second joining request are not stored,
the first packet transfer apparatus stores information indicating delivery permission or delivery rejection in the delivery control table in association with the group address and the terminal identification information in accordance with the notification, and
the first packet transfer apparatus receives multicast data including the group address from the second packet transfer apparatus and transmits, with reference to the delivery control table, the received multicast data and/or the copied multicast data to one user terminal or the plural user terminals in accordance with the terminal identification information of the entries in which the information indicating delivery permission is stored in association with the group address.

2. A network system according to claim 1, wherein
the first packet transfer apparatus stores, for each of the pieces of terminal identification information, delivery start time and delivery end time of the multicast data and transmits, when it is judged that the user terminal leaves the multicast group, the terminal identification information of the user terminal, the delivery start time, and the delivery end time to the second packet transfer apparatus, and
the second packet transfer apparatus transmits accounting information based on the delivery start time and the delivery end time to an accounting server that manages accounting.

3. A network system according to claim 1, wherein
the first packet transfer apparatus stores, for each of the pieces of terminal identification information, traffic of delivery of the multicast data and transmits, when it is judged that the user terminal leaves the multicast group, the terminal identification information of the user terminal and the traffic to the second packet transfer apparatus, and
the second packet transfer apparatus transmits accounting information based on the traffic to an accounting server that manages accounting.

4. A network system according to claim 2, wherein
the first packet transfer apparatus judges that the user terminal leaves the multicast group according to a fact that a leaving declaration is received from the user terminal, a joining check is transmitted to the user terminal and a response to the joining check is not received within a predetermined time, or notification indicating that the point to point connection with the user terminal is disconnected is received from the second packet transfer apparatus.

5. The network system according to claim 1, wherein
the second packet transfer apparatus includes a connection management table in which connection identification information for identifying connection to the first packet transfer apparatus is stored in association with the group address,
the first packet transfer apparatus and the second packet transfer apparatus establish a connection for communicating the multicast data between the first and second packet transfer apparatus,
the second packet transfer apparatus stores the group address and the connection identification information in the connection management table in association with each other,
the second packet transfer apparatus receives multicast data including the group address, and transmits, with reference to the connection management table, the multicast data to the first packet transfer apparatus through the established connection for communicating the multicast data in accordance with connection information corresponding to the group address.

6. A network system according to claim 1, wherein
the second packet transfer apparatus includes a delivery information table in which the identification information of the user terminal is stored in association with the group address received from the server,
the second packet transfer apparatus transfers respective pieces of information of the delivery information table to the first packet transfer apparatus,
the first packet transfer apparatus transmits the respective pieces of information of the delivery control table to the second packet transfer apparatus, and
thereby the information of the delivery control table of the first packet transfer apparatus and the information of the delivery information table of the second packet transfer apparatus are consistent.

7. A network system according to claim 1, wherein
the second packet transfer apparatus acquires, when the group address and terminal identification information coinciding with the group address and the terminal identification information included in the second joining request are not stored, a group address of the multicast group that the user terminal can join from the server again and performs the comparison again using the group address acquired anew.

8. A network system comprising:
a first packet transfer apparatus that terminates plural user terminals, copies received multicast data, and transfers the multicast data to each of the user terminals;
a second packet transfer apparatus that communicates with the plural user terminals point to point through the first packet transfer apparatus; and
a server that outputs a group address of a multicast group that the user terminal can join to the second packet transfer apparatus,
wherein
the first packet transfer apparatus includes a delivery control table in which entries including a group address, terminal identification information of the user terminal, information indicating delivery permission or delivery rejection, and information indicating reception or non-reception of a joining request are stored,
the second packet transfer apparatus receives a connection request for point to point connection from the user terminal and acquires the group address of the multicast group that the user terminal can join from the server,
the second packet transfer apparatus transmits notification including the acquired group address and the terminal identification of the user terminal to the first packet transfer apparatus,
the first packet transfer apparatus stores the group address and the terminal identifier included in the notification and the information indicating delivery permission into the delivery control table in association with each other,
the first packet transfer apparatus receives, from the user terminal, a joining request for joining a multicast group including the group address set in advance and the terminal identification information of the user terminal and stores information indicating reception of the joining request in association with corresponding group address and terminal identification information of the delivery control table, and
the first packet transfer apparatus receives multicast data including the group address from the second packet transfer apparatus, and transmits, with reference to the delivery control table, the received multicast data and/or the copied multicast data to one user terminal or the plural user terminals in accordance with the terminal identification information of the entries in which the information indicating reception of the joining request and the information indicating delivery permission are stored in association with the group address.

9. A network system comprising:
a first packet transfer apparatus that terminates plural user terminals, copies received multicast data, and transfers the multicast data to each of the user terminals;
a second packet transfer apparatus that communicates with the plural user terminals point to point through the first packet transfer apparatus; and
a server that outputs a group address of a multicast group that the user terminal can join to the second packet transfer apparatus and receives accounting start notification and accounting end notification to thereby perform accounting for each of pieces of terminal identification information,
wherein
the first packet transfer apparatus includes a delivery control table in which entries including a group address, terminal identification information of the user terminal and information indicating delivery permission or delivery rejection are stored,
the second packet transfer apparatus receives a connection request for point to point connection from the user terminal and acquires the group address of the multicast group that the user terminal can join from the server,
the second packet transfer apparatus stores the acquired group address and the terminal identification information of the user terminal in association with each other,
the first packet transfer apparatus receives, from the user terminal, a joining request for joining a multicast group including the group address set in advance and the terminal identification information of the user terminal, snoops the joining request, stores the group address and the terminal identification information in the delivery control table, and transfers the joining request to the second packet transfer apparatus,
the second packet transfer apparatus transmits the accounting start notification including the group address and/or the terminal identification information included in the received joining request to the server,
the second packet transfer apparatus compares the group address and the terminal identification information included in the received joining request and the stored group address and the terminal identification information, and transmits, to the first packet transfer apparatus, notification indicating delivery permission when the group address and terminal identification information coinciding with the group address and the terminal identification information included in the received joining request are stored, and notification indicating delivery rejection when the group address and terminal identification information coinciding with the group address and the terminal identification information included in the received joining request are not stored,
the first packet transfer apparatus stores information indicating delivery permission or delivery rejection in the delivery control table in association with the group address and the terminal identification information in accordance with the notification,
the first packet transfer apparatus receives multicast data including the group address from the second packet transfer apparatus, and transmits, with reference to the delivery control table, the received multicast data and/or the copied multicast data to one user terminal or the plural user terminals in accordance with the terminal identification information of the entries in which the information indicating delivery permission is stored in association with the group address, and
the second packet transfer apparatus receives a leaving declaration including the group address and the terminal identification information from the user terminal through the first packet transfer apparatus and transmits the accounting end notification including the group address and/or the terminal identification information included in the received leaving declaration to the server.

10. A network system according to claim 9, wherein
the second packet transfer apparatus receives a participation request from the user terminal and establishes connection for communicating the multicast data between the first packet transfer apparatus and the second packet transfer apparatus, and
the second packet transfer apparatus receives multicast data including the group address and transfers the multicast data to the first packet transfer apparatus through the established connection.
